(19) United States
(12) Patent Application Publication
(10) Pub. No.: US 2025/0231502 A1
(43) Pub. Date: Jul. 17, 2025

(54) POLYESTER RESIN EMULSION FOR TONER, TONER, METHOD OF MANUFACTURING RESIN PARTICLE, AND METHOD OF MANUFACTURING TONER

(71) Applicants: Shinya Nakayama, Kanagawa (JP); Junichi Watanabe, Kanagawa (JP); Akinori Saitoh, Kanagawa (JP); Masahiro Yukikawa, Kanagawa (JP); akio Takei, Kanagawa (JP)

(72) Inventors: Shinya Nakayama, Kanagawa (JP); Junichi Watanabe, Kanagawa (JP); Akinori Saitoh, Kanagawa (JP); Masahiro Yukikawa, Kanagawa (JP); akio Takei, Kanagawa (JP)

(73) Assignee: Ricoh Company, Ltd., Tokyo (JP)

(21) Appl. No.: 19/016,329

(22) Filed: Jan. 10, 2025

(30) Foreign Application Priority Data
Jan. 12, 2024 (JP) 2024-002950

(51) Int. Cl. G03G 9/093; C09D 5/02; C09D 167/02; G03G 9/08

(52) U.S. Cl. CPC G03G 9/09328; C09D 5/022; C09D 167/02; G03G 9/0804

(57) ABSTRACT

A polyester resin emulsion for toner contains an aqueous medium and resin particles S dispersed in the aqueous medium, the resin particles S containing a polyester resin A of a polycondensate of an alcohol component and a carboxylic acid component,
wherein the alcohol component comprises tri- or tetra-valent alcohol having a straight chained or branched aliphatic saturated hydrocarbon backbone with 4 to 6 carbon atoms,
the following relationship is satisfied,

$$0.3 \leq OHV / AV \leq 1. ,$$

where AV (mgKOH/g) represents an acid value of the polyester resin A and OHV (mgKOH/g) represents a hydroxyl value of the polyester resin A,
AV is between 10 mgKOH/g and 25 mgKOH/g, and
the polyester resin A has a repeated unit derived from polyethylene terephthalate of a condensate of terephthalic acid and ethylene glycol in an amount between 40 percent by mass and 70 percent by mass.

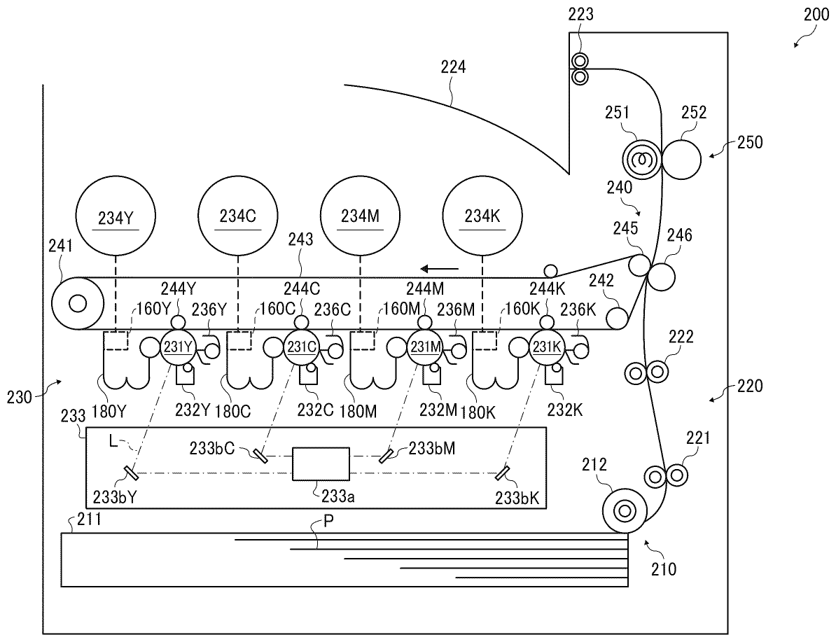

### CROSS-REFERENCE TO RELATED APPLICATIONS

This patent application is based on and claims priority pursuant to 35 U.S.C. § 119 to Japanese Patent Application No. 2024-002950, filed on Jan. 12, 2024, in the Japan Patent Office, the entire disclosure of which is hereby incorporated by reference herein.

### BACKGROUND

### Technical Field

The present disclosure is related to a polyester resin emulsion for toner, a toner, a method of manufacturing resin particle, and a method of manufacturing toner.

### Description of the Related Art

Toners used in electrophotographic image forming apparatuses are required to exhibit excellent low-temperature fixability due to market demands for energy efficiency. Additionally, toners with excellent blocking resistance are also needed to prevent fusion between toner particles, even under severe conditions such as high temperature and high humidity, as well as toners with superior mechanical durability to withstand the stress from the high-speed performance by image forming apparatuses.

In recent years, toners with a so-called core-shell structure—where a shell formed from shell particles is applied to the surface of core particles to enhance heat resistance and mechanical durability—have been actively developed. Various methods of forming core-shell toners have been proposed and implemented. Among them, chemical toners using polyester resin with excellent low-temperature fixability for both core and shell particles are mainstream.

### SUMMARY

According to embodiments of the present disclosure, a polyester resin emulsion for toner is provided which contains an aqueous medium and resin particles S dispersed in the aqueous medium, the resin particles S containing a polyester resin A of a polycondensate of an alcohol component and a carboxylic acid component,
wherein the alcohol component comprises tri- or tetra-valent alcohol having a straight chained or branched aliphatic saturated hydrocarbon backbone with 4 to 6 carbon atoms,
the following relationship is satisfied,

$$0.3 \leq OHV / AV \leq 1. ,$$

where AV (mgKOH/g) represents an acid value of the polyester resin A and OHV (mgKOH/g) represents a hydroxyl value of the polyester resin A,
AV is between 10 mgKOH/g and 25 mgKOH/g, and
the polyester resin A has a repeated unit derived from polyethylene terephthalate of a condensate of terephthalic acid and ethylene glycol in an amount between 40 percent by mass and 70 percent by mass.

As another aspect of embodiments of the present disclosure, a method of manufacturing resin particles is provided which includes dissolving or dispersing at least a polyester resin and a release agent in an organic solvent to obtain a solution or a dispersion, suspending the solution or the dispersion to produce a liquid dispersion of core particles, adding the polyester resin emulsion mentioned above to the liquid dispersion of the core particles to form a shell on a surface of the core particles, and removing the organic solvent to manufacture the resin particles with a core-shell structure of the core particles comprising a binder resin and the shell covering the core particles.

As another aspect of embodiments of the present disclosure, a method of manufacturing a toner is provided which includes dissolving or dispersing at least a polyester resin and a release agent in an organic solvent to obtain a solution or a dispersion, suspending the solution or the dispersion to produce a liquid dispersion of core particles, adding the polyester resin emulsion mentioned above to the liquid dispersion of the core particles to form a shell on a surface of the core particles, and removing the organic solvent to manufacture the toner with a core-shell structure of the core particles comprising a binder resin and the shell covering the core particles.

### BRIEF DESCRIPTION OF THE DRAWING

Various other objects, features and attendant advantages of the present disclosure will be more fully appreciated as the same become better understood from the detailed description when considered in connection with the accompanying drawing, in which like reference characters designate like corresponding parts throughout and wherein

FIGURE is a schematic diagram illustrating an example of the image forming apparatus according to the present disclosure.

The accompanying drawings are intended to depict example embodiments of the present invention and should not be interpreted to limit the scope thereof. The accompanying drawings are not to be considered as drawn to scale unless explicitly noted. Also, identical or similar reference numerals designate identical or similar components throughout the several views.

### DESCRIPTION OF THE EMBODIMENTS

The terminology used herein is for the purpose of describing particular embodiments only and is not intended to be limiting of the present invention. As used herein, the singular forms “a,” “an,” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Embodiments of the present invention are described in detail below with reference to accompanying drawings. In describing embodiments illustrated in the drawings, specific terminology is employed for the sake of clarity. However, the disclosure of this patent specification is not intended to be limited to the specific terminology so selected, and it is to be understood that each specific element includes all technical equivalents that have a similar function, operate in a similar manner, and achieve a similar result.

For the sake of simplicity, the same reference number will be given to identical constituent elements such as parts and materials having the same functions and redundant descriptions thereof omitted unless otherwise stated.

According to the present disclosure, a polyester resin emulsion for toner is provided which forms toner that achieves excellent mechanical durability and ensures excellent charging stability for a long extended use.

Toners with a core-shell structure are known that, in terms of low-temperature fixability, heat resistance stability, charging stability, and mechanical durability of the toner, it is highly necessary for the shell formed on the surface of the core particle to be uniformly distributed, covering the entire of the core particle. More specifically, unless the shell is uniformly distributed and cover the entire of the core particle, the mechanical durability of the toner decreases, leading to concerns that the shell layer may peel off from the core particle due to development stress inside the image forming apparatus, resulting in significant deterioration of various toner properties.

For Example, a toner for electrostatic charge development in which polyethylene terephthalate (PET) is mixed with the resin resent in both the core and shell portions has been proposed in Japanese Patent No. 6632066 or Japanese Unexamined Patent Application Publication No. 2017-111416.

In these core-shell structure toners, the attachment of the shell to the core particles is critical; if the shell is not uniformly attached or peels off due to stress, such as agitation within the developing unit, it can negatively impact the stability of toner properties, such as chargeability.

In the art described in Japanese Unexamined Patent Application Publication No. 2017-111416 mentioned above, the introduction of polyethylene terephthalate (PET) into the shell portion of toners with a core-shell structure is used to improve the durability of the toner and reduces wax exposure on the toner surface. However, introducing polyethylene terephthalate (PET) into the shell particles forming the shell portion is concerning because it reduces the hydrophobicity of the shell particles, leading to decreased aggregation of the core and shell particles, making it difficult to create a uniform shell on the surface of the core particle.

Through diligent investigation, the inventors of the present invention discovered that by using an emulsion in which Polyester Resin A—with an acid value (AV, in mgKOH/g) to hydroxyl value (OHV, in mgKOH/g) ratio within a specific range—is dispersed in an aqueous medium to form a core-shell structure, the aggregation and uniformity of shell particles on the core particles are improved. This approach results in toner and developing agents with enhanced mechanical durability and excellent charge stability over prolonged use. What is discovered is detailed below.

In the production of toner with a core-shell structure, a resin emulsion containing shell particles is dispersed into a dispersion of core particles. The shell particles are then aggregated onto the surface of the core particles by applying collision energy from stirring, thermal energy from heating, and an aggregating agent, such as an inorganic metal salt. The properties of the resin constituting the shell particles not only affect the stability of the emulsion and the aggregation of shell particles with core particles but also influence adhesion with core particles during the heating fusion to form the shell layer.

Representative characteristics of the resin constituting the shell particle include acid value AV, hydroxyl value OHV, hydrophilicity/hydrophobicity, compatibility with solvents, and melt viscosity. Among these, the inventors of the present invention have found that the ratio of hydroxyl value OHV to acid value AV in the resin constituting the shell particle of 0.30 to 1.00 enhances the aggregation of shell particles to the surface of core particles, leading to uniform aggregation and distribution on the surface of core particles (uniform aggregation), and enables the formation of the shell layer without detachment from the surface of core particles even under stirring stress in the developing device. This ratio (OHV/AV) can be controlled by using a trivalent or tetravalent alcohol having a backbone of a straight chained or branched aliphatic saturated hydrocarbon acid with a carbon number of 4 to 6 as the alcohol component in the resin.

The present disclosure is described in detail below.

### Polyester Resin Emulsion for Toner

The polyester resin emulsion of the present disclosure for toner is resin particles S—containing polyester resin A—that are dispersed in an aqueous medium. The polyester resin emulsion may optionally contain other resins and other components.

### Resin Particle S

The resin particle S contains the polyester resin A and other optional components.

### Volume Average Particle Diameter of Resin Particle S

The volume average particle size of the resin particles S in the polyester resin emulsion for toner is not specifically restricted and can be chosen appropriately depending on the purpose. It is preferable that the median diameter D50 be between 0.05 μm and 0.8 μm, with a more preferred range being between 0.1 μm and 0.5 μm, and even more preferably between 0.15 μm and 0.3 μm.

A volume average particle size of the resin particles S at or above 0.05 μm in median diameter D50 is preferable to achieve efficient aggregation of the shell particle on the core particle, enabling the formation of a shell with sufficient thickness on the toner surface.

A volume average particle size of the resin particles S of at or below 0.8 μm in median diameter D50 is preferable to achieve uniform aggregation of the shell particle on the core particle, enabling the formation of a sufficiently uniform shell.

The method of measuring the median diameter D50 is not particularly limited and can be suitably selected to suit to a particular application. One way of measuring is to use a laser diffraction particle size analyzer LA-920 (available from HORIBA, Ltd.).

### Polyester Resin A

The polyester resin A is a polycondensate of an alcohol component with a carboxylic acid and has repeated units derived from polyethylene terephthalate (PET). The polyester resin A may optionally contain other alcohols and other resins.

### Alcohol Component

The alcohol component mentioned above includes tri- or tetra-valent alcohols with straight chained or branched aliphatic saturated hydrocarbon backbone containing 4 to 6 carbon atoms.

In this specification, the term “alcohol” may be used simply to refer to a “tri- or tetra-valent alcohol with a straight chained or branched aliphatic saturated hydrocarbon backbone containing 4 to 6 carbon atoms. Any alcohol not falling under the category of “tri- or tetra-valent alcohols with a straight chained or branched aliphatic saturated hydrocarbon backbone containing 4 to 6 carbon atoms” may be termed as “other alcohols.

In the present specification, “straight-chained” refers to a structure indicating a carbon chain (also referred to as main chain) connected by the minimum number of bonds between two oxygen atoms derived from hydroxyl groups in the monomer units of the alcohol component, which are randomly selected. This structure excludes carbon-carbon bonds other than the main chain.

In this specification, “branched” refers to a structure indicating carbon-carbon bonds other than the main chain.

The polyester resin A, which contains, as the alcohol component, a tri- or tetra-valent alcohol with a backbone of a straight chained or branched aliphatic saturated hydrocarbon backbone containing 4 to 6 carbon atoms can control the hydroxyl value OHV of the polyester resin A and enhance the aggregation and adhesiveness to core particles.

As for the alcohol, there are no particular restrictions as long as it is a tri- or tetra-valent alcohol with a backbone of a straight chained or branched aliphatic saturated hydrocarbon backbone containing 4 to 6 carbon atoms. It can be appropriately selected depending on the purpose. For example, tri-valent aliphatic saturated hydrocarbon with 4 to 6 carbon atoms or tetra-valent aliphatic alcohols with 4 to 6 carbon atoms can be listed.

Specific examples of trivalent aliphatic alcohols with 4 to 6 carbon atoms include, but are not limited to, 1,2,3-butanetriol, 1,2,4-butanetriol, trimethylolethane, 1,2,3-pentanetriol, 1,2,4-pentanetriol, 1,2,5-pentanetriol, 1,3,5-pentanetriol, 2,3,4-pentanetriol, trimethylol propane, 1,2,3-hexanetriol, 1,2,6-hexanetriol, 1,3,5-hexanetriol, and 2-isopropylpropane-1,2,3-triol.

Specific examples of tetravalent aliphatic alcohols with 4 to 6 carbon atoms include, but are not limited to, pentaerythritol, 1,2,3,4-butanetetraol, 1,2,3,4-pentanetetraol, 1,2,3,5-pentanetetraol, 1,2,4,5-pentanetetraol, 1,2,4,5-hexanetetraol, and 1,2,5,6-hexanetetraol.

These alcohols can be used alone or in combination.

The proportion of the alcohol is not particularly limited and can be suitably selected to suit to a particular application. It is preferable that the alcohol content in the polyester resin A be from 0.5 mol percent to 10 mol percent, with a more preferable range being from 2 mol percent to 5 mol percent, relative to the total amount of alcohol component in the polyester resin A.

When the proportion of the alcohol is at least 0.5 mol percent to the total amount of alcohol component in the polyester resin A, it can adequately resolve issues such as insufficient aggregation of shell particles to core particles, resulting in an increase in the number of shell particles unincorporated into the shell.

To the contrary, when the proportion of the alcohol is at most 10 mol percent to the total amount of alcohol component in the polyester resin A, it can effectively resolve issues such as an increased branched chain of the polyester resin A. This increase raises a concern about reduced melt viscosity of the shell in toners, which in turn leads to inadequate heat resistance and hot offset resistance.

### Carboxylic Acid

Carboxylic acid is not particularly limited and can be suitably selected depending on the purpose.

Specific examples include, but are not limited to, aliphatic dicarboxylic acids or their anhydrides such as oxalic acid, adipic acid, succinic acid, azelaic acid, dodecanedioic acid, maleic acid, citraconic acid, itaconic acid, alkene succinic acid, and fumaric acid; polyfunctional aliphatic carboxylic acids or their anhydrides with three or more carboxyl groups such as 1,2,4-butanetricarboxylic acid, 1,2,5-hexanetricarboxylic acid, 1,3-dicarboxy-2-methyl-2-methylenepropane, tetra(methylenecarboxy) methane, 1,2,7,8-octanetetracarboxylic acid; aromatic dicarboxylic acids such as phthalic acid, isophthalic acid, terephthalic acid, naphthalenedicarboxylic acid; polyfunctional aromatic carboxylic acids with three or more carboxyl groups such as trimellitic acid, pyromellitic acid, 1,2,4-benzenetricarboxylic acid, 1,2,5-benzenetricarboxylic acid, 2,5,7-naphthalenetricarboxylic acid, 1,2,4-naphthalenetricarboxylic acid, and their anhydrides and partial lower alkyl esters.

These carboxylic acids can be used alone or in combination.

The method of polycondensation between the alcohol component and the carboxylic acid component is not particularly limited and can be suitably selected depending on the purpose. One such polycondensation method can be conducted at a temperature ranging from 180 to 250 degrees Celsius under an inert gas atmosphere and in the presence of an esterification catalyst.

The esterification catalyst is not particularly limited and can be suitably selected to suit to a particular application. It includes, for example, titanium compounds and tin (II) compounds not having Sn—C bonds.

These esterification catalysts can be used alone or in combination.

The titanium compounds are not particularly limited and can be suitably selected depending on the purpose.

Specific examples include, but are not limited to, titanium isopropylate bis-triethanolamine, titanium isopropylate bis-diethanolamine, titanium pentylate bis-triethanolamine, titanium dietholate bis-triethanolamine, titanium hydroxyoctylate bis-triethanolamine, titanium stearate bis-triethanolamine, titanium triisopropylate triethanolamine, titanium monopropylate tris(triethanolamine), tetra-n-butyl titanate, tetrapropyl titanate, tetra-stearyl titanate, tetra-milistyl titanate, tetra-octyl titanate, dioctyl dihydroxyoctyl titanate, and dimilistyl dioctyl titanate.

Among these, titanium compounds with Ti—O bonds are preferable due to their high activity and ability to reduce the proportion of low molecular weight components of polyester resins. Compounds with alkoxyl, alkenyl oxy, or acyl oxy groups, totaling 1 to 28 carbon atoms, are even more preferable.

The content of the titanium compounds is not particularly limited and can be suitably selected depending on the purpose. The content preferably ranges from 0.01 to 1.0 part by mass, with a preference for 0.1 to 0.5 parts by mass, relative to the total amount of 100 parts by mass of the alcohol component and the carboxylic acid component. This range helps to control the reaction speed of polymerization and ensures the quality of polyester resins.

As for tin (II) compounds not having Sn—C bonds, there are no specific restrictions, and they can be suitably selected depending on the purpose. Tin (II) compounds with Sn—O bonds or Sn—X bonds (where X represents a halogen atom) are preferable, with tin (II) compounds having Sn—O bonds being even more preferable.

Specific examples of tin (II) compounds having Sn—O bonds include, but are not limited to, carboxylic acid tin (II) compounds with carbon numbers ranging from 2 to 28, such as stannous oxalate, stannous acetate, stannous octanoate, stannous 2-ethylhexanoate, stannous laurate, stannous stearate, and stannous oleate; alkoxyl tin (II) compounds with carbon numbers ranging from 2 to 28, such as octyloxyl tin (II), lauryloxyl tin (II), stearyloxyl tin (II), and oleyloxyl tin (II); tin oxide (II); and tin sulfate (II).

Specific examples of tin (II) compounds having Sn—X bonds include halogenated tin (II) compounds such as tin (II) chloride and tin (II) bromide.

The content of the tin (II) compounds is not particularly limited and can be suitably selected depending on the purpose. The content preferably ranges from 0.01 to 1.0 part by mass, with a preference for 0.1 to 0.5 parts by mass, relative to the total amount of 100 percent by mass of the alcohol component and the carboxylic acid component. This range helps to control the reaction speed of polymerization and ensures the quality of polyester resins.

In the case of using both the titanium compounds and the tin (II) compounds in combination, the total content of the titanium compounds and the tin (II) compounds is not particularly limited and can be suitably selected depending on the purpose. The content of the titanium compounds and tin (II) compounds is not particularly limited and can be suitably selected depending on the purpose. The content preferably ranges from 0.01 to 1.0 part by mass, with a preference for 0.1 to 0.5 parts by mass, relative to the total amount of 100 parts by mass of the alcohol component and the carboxylic acid component. This range helps to control the reaction speed of polymerization and ensures the quality of polyester resins.

### Other Alcohol

In the polyester resin A of the present disclosure, other alcohols may also be included in addition to the alcohol mentioned above.

These other alcohols are not particularly limited and can be suitably selected depending on the purpose.

Specific examples include, but are not limited to, aliphatic diols such as ethylene glycol, 1,2-propanediol, 1,3-propanediol, 1,4-butanediol, 2,3-butanediol, 3-methyl-1,5-pentanediol, 1,6-hexanediol, neopentyl glycol, 2-ethyl-1,3-hexanediol, 1,8-octanediol, 1,10-decanediol, 1,12-dodecanediol; diols with oxyalkylene groups such as diethylene glycol, triethylene glycol, dipropylene glycol, polyethylene glycol, polypropylene glycol, polytetramethylene glycol; alicyclic diols such as 1,4-cyclohexanedimethanol, 1,4-sorbitan, hydrogenated bisphenol A; adducts of alkylene oxides such as ethylene oxide, propylene oxide, or butylene oxide with the alicyclic diols; bisphenols such as bisphenol A, bisphenol F, bisphenol S; adducts of alkylene oxides such as alkylene oxides such as ethylene oxide, propylene oxide, or butylene oxide with the bisphenols; tri- or higher alicyclic alcohols such as heptanetriol, octanetriol, decanetriol, sorbitol, dipentaerythritol; polyphenols such as trisphenol, phenol novolak, cresol novolak; adducts of alkylene oxide such as ethylene oxide, propylene oxide, and butylene oxide with the polyphenols.

Among these, 1,2-propanediol, 1,3-propanediol, 1,4-butanediol, and 2,3-butanediol are preferable. By using these diols as other alcohol components in the polyester resin A, it is possible to form a shell with excellent balance between low-temperature fixability and mechanical durability, resulting in good aggregation and uniformity of shell particles on core particles, making it preferable. Additionally, to reduce carbon dioxide emissions when the resultant toner is ultimately incinerated, it is more preferable for these diols to be derived from biomass.

Furthermore, in this specification, 1,2-propanediol, 1,3-propanediol, 1,4-butanediol, and 2,3-butanediol may be referred to as diols (D).

These other alcohols can be used alone or in combination.

In the case of 1,2-propanediol, 1,3-propanediol, 1,4-butanediol, and 2,3-butanediol as the other alcohols, it is preferable that at least one of these diols selected from them be present in the total alcohol component in an amount of at least 30 mol percent, more preferably at least 50 mol percent, and even more preferably at least 80 mol percent. In other words, it is preferable that the total content of these diols be at least 30 mol percent of the entire amount of the alcohol component in the polyester resin A, more preferably at least 50 mol percent, and even more preferably at least 80 mol percent.

When the total content of 1,2-propanediol, 1,3-propanediol, 1,4-butanediol, and 2,3-butanediol is 30 mol or more percent by mol relative to the total amount of the alcohol component in the polyester resin A, it is suitable to achieve good low-temperature fixability, mechanical durability, and environmental impact reduction.

Repeated Unit Derived from Polyethylene Terephthalate (PET)

The polyester resin A of the present disclosure also contains repeated units derived from the condensate of terephthalic acid and ethylene glycol, known as polyethylene terephthalate (PET), in addition to the above components. In this specification, the “repeated units derived from polyethylene terephthalate (PET)” may be referred to as “PET repeated units.”

The polyester resin A containing these PET repeated units exhibits excellent mechanical durability, making it suitable for application in the shell of toners with a core-shell structure. Furthermore, from the perspective of reducing environmental impact such as reducing the use of petroleum resources, it is preferable to use retrieved PET, also known as recycled PET, as the PET material.

The polyester resin A containing the aforementioned PET repeated unit can be obtained by subjecting the polyester resin A materials to condensation polymerization during ester exchange reactions.

As mentioned above, in the typical method of introducing PET into shell particles to form a shell, the hydrophobicity of the shell particles decreases, leading to reduced aggregation of core and shell particles, thus making it challenging to achieve a uniform shell on the surface of the core particles. On the other hand, the polyester resin emulsion for toner according to the present disclosure maintains moderate hydrophobicity because the ratio (OHV/AV) of the polyester resin A is 0.30 to 1.00. Thus, a condition is created where heteroaggregation with core particles occurs preferentially, and even when PET is introduced into the shell particles, it does not impair the aggregation or adhesion with the core particles. Moreover, the shell is not easily detached from the surface of the core particle, achieving good charging stability.

There is no specific limitation on the content of the PET repeated unit, and it can be appropriately selected according to the purpose. It is preferable that the content of the PET repeated unit be 40 to 70 percent by mass of the total amount of the polyester resin A, with a more preferable range being 50 to 60 percent by mass.

The inclusion of the PET repeated unit at least 40 percent by mass of the total amount of the polyester resin A is preferable to achieve excellent mechanical durability.

On the other hand, the inclusion of the PET repeated unit at most 70 percent by mass of the total amount of the polyester resin A is preferable for improved solubility in organic solvents and low-temperature fixing properties.

### Ratio (OHV/AV) of Polyester Resin A

In the present disclosure, it is preferable that the ratio (OHV/AV) of hydroxyl value OHV of the polyester resin A to its acid value AV be 0.30 to 1.00, with a more preferable range being 0.65 to 1.0. Furthermore, in the present specification, the ratio of hydroxyl value OHV of the polyester resin A to its acid value AV is also referred to as OHV/AV ratio.

An OHV/AV ratio between 0.30 and 1.00 is preferable for addressing issues leading to degradation of toner quality, such as poor aggregation of shell particles on core particles, inability to uniformly distribute shell particles on the surface of core particles, occurrence of defects in the formed shell, increase in the proportion of shell particles that do not aggregate with core particles, and resulting deposition of such non-aggregating shell particles as fines in the toner. Additionally, it is preferable for shell particles to adhere more firmly to core particles during the formation of the shell by heating and melting the shell particles, making the shell less prone to peeling.

Furthermore, setting the OHV/AV ratio of the toner within this range ensures excellent charge stability, providing a highly stable charge level under the agitation stress within a developing device.

In the present disclosure, the acid value AV of the polyester resin A is from 10 mgKOH/g to 25 mgKOH/g, with a preferable range of from 18 mgKOH/g to 25 mgKOH/g.

When the acid value AV is at least 10 mg KOH/g, the stability of the emulsion improves, resolving issues related to emulsification resistance and enhancing the aggregation of shell particles onto core particles, making it advantageous. Furthermore, the toner exhibits appropriate chargeability and excellent charge retention.

When the acid value AV is no more than 25 mg KOH/g, the toner maintains stable chargeability under environmental fluctuations, and the aggregation of shell particles onto core particles remains preferable.

The acid value AV of the polyester resin A can be measured according to JIS K0070 (Test methods for acid value, saponification value, ester value, iodine value, hydroxyl value and unsaponifiable matter of chemical products).

When the acid value AV of the polyester resin is between 10 mg KOH/g and 25 mg KOH/g, the hydroxyl value OHV is preferably between 3 mg KOH/g and 25 mg KOH/g.

The hydroxyl value OHV of the polyester resin A can be measured according to JIS K0070 (Test methods for acid value, saponification value, ester value, iodine value, hydroxyl value and unsaponifiable matter of chemical products).

### Glass Transition Temperature Tg of Polyester Resin A

The glass transition temperature determined by the second heating in differential scanning calorimetry DSC is not particularly limited and can be suitably selected to suit to a particular application. The glass transition temperature Tg is preferably between 65 degrees Celsius and 75 degrees Celsius. Additionally, in the present specification, the “glass transition temperature determined by the second heating in differential scanning calorimetry (DSC)” may be referred to as “Tg2nd”. A Tg2nd of the polyester resin A is at or above 65 degrees Celsius is preferable to improve the heat resistance of toner during storage.

A Tg2nd of the polyester resin A is at or below 75 degrees Celsius is preferable to improve the low temperature fixability of toner.

There is no specific limitation on the method of measuring the glass transition temperature Tg of the aforementioned polyester resin A. For example, it can be measured using a differential scanning calorimeter (DSC) (e.g., Q-200 by TA Instruments). One such measurement method for the glass transition temperature Tg is as follows.

### Example of Measurement Method for Glass Transition Temperature Tg

A total of 5.0 mg of the resin sample is put into an aluminum sample pan, held on a holder unit, and placed in an electric furnace. A total of 10 mg of alumina is placed in an aluminum sample pan as a reference. Under a nitrogen atmosphere, the reference is heated from 0 to 150 degrees Celsius at a heating rate of 10 degrees/minute (first heating), then cooled from 150 to 0 degrees Celsius at a cooling rate of 10 degrees/minute (cooling process), and heated again from 0 to 150 degrees Celsius at a heating rate of 10 degrees/minute (second heating). The endothermic and exothermic change during these processes is measured and the graph of temperature against the amount of heat flow is plotted to create a DSC curve, followed by analysis using the analysis program in the Q-200 system. The DSC curve for the second heating cycle is selected. The glass transition temperature of the polyester resin A is determined from the intersection of the baseline extension of the DSC curve at temperatures lower than the enthalpy relaxation and the tangent indicating the maximum slope during enthalpy relaxation.

### Weight Average Molecular Weight of Polyester Resin A

For the weight average molecular weight Mw of the aforementioned polyester resin A measured by gel permeation chromatography (GPC), there are no specific limitations, and it can be chosen as appropriate depending on the purpose. It is preferable for Mw to be from 0.8×10⁴ to 1×10⁵, with a more preferred range being from 1×10⁴ to 5×10⁴. In the present specification, “weight average molecular weight Mw measured by gel permeation chromatography (GPC)” may simply be referred to as “weight average molecular weight Mw.”

A weight average molecular weight Mw of the polyester resin A of at least 0.8×10⁴ is preferable to improve the mechanical durability of toner.

A weight average molecular weight Mw of the polyester resin A of at most 5×10⁴ is preferable to improve the low temperature fixability of toner.

There are no specific limitations on the method of measuring the weight average molecular weight Mw, but it can be measured using a gel permeation chromatography (GPC) measuring device (for example, HLC-8220GPC by Tosoh Corporation). One such measuring method for the weight average molecular weight Mw is as follows.

### Example of Method of Manufacturing Weight Average Molecular Weight Mw

The column used is a TSKgel SuperHZM-H 15 cm 3-column (available from Tosoh Corporation). The polyester resin A to be measured is dissolved in tetrahydrofuran (THF) (containing stabilizers, available from Fujifilm Wako Pure Chemical Corporation) to prepare a 0.15 percent by mass solution. After filtration through a 0.2 μm filter, the filtrate is used as the sample. A total of 100 μl of the THF sample solution is injected into the measuring device, and measurements are conducted at a flow rate of 0.35 ml/min at a temperature of 40 degrees Celsius. The molecular weight is calculated using a calibration curve created by monodisperse polystyrene standard samples. For the polystyrene standard samples, THF solutions (solutions A to C) of three types of monodisperse polystyrene standard samples from the Showdex STANDARD series available from Showa Denko Co., Ltd. are prepared. Measurements are conducted under the above conditions, and the retention time of the peak top is used to create the calibration curve for the light scattering molecular weight of the monodisperse polystyrene standard samples. A refractive index (RI) detector is used as a detector.
Solution A: S-7300 2.5 mg, S-602 2.5 mg, S-46 2.5 mg, S-2.8 2.5 mg, THF 50 mL.
Solution B: S-3500 2.5 mg, S-277 2.5 mg, S-18 2.5 mg, S-1.3 2.5 mg, THF 50 mL
Solution C: S-1700 2.5 mg, S-136 2.5 mg, S-6.7 2.5 mg, toluene 2.5 mg, THF 50 mL

### Other Resins

The polyester resin emulsion for toner may optionally furthermore include other resins in addition to the polyester resin A as long as it does not have an adverse impact on the effects of the present disclosure.

There is no specific limitation to the other resins and it can be suitably selected to suit to a particular application.

Specific examples include, but are not limited to, styrene polymers and substituted styrene polymers such as polystyrene, poly-p-styrene, and polyvinyltoluene; styrene copolymers such as styrene-p-chlorostyrene copolymers, styrene-propylene copolymers, styrene-vinyltoluene copolymers, styrene-methyl acrylate copolymers, styrene-ethyl acrylate copolymers, styrene-methacrylate copolymers, styrene-methyl methacrylate copolymers, styrene-ethyl methacrylate copolymers, styrene-butyl methacrylate copolymers, styrene-α-methyl chloromethacrylate copolymers, styrene-acrylonitrile copolymers, styrene-vinyl methyl ether copolymers, styrene-vinyl methyl ketone copolymers, styrene-butadiene copolymers, styrene-isopropyl copolymers, and styrene-maleic acid ester copolymers; and other resins such as polymethyl methacrylate, polybutyl methacrylate, polyvinyl chloride, polyvinyl acetate, polyethylene, polyesters, epoxy resins, polyurethane resins, polyvinyl butyral resins, polyacrylic resins, rosin, modified rosins, terpene resins, phenol resins, aliphatic or aromatic hydrocarbon resins, aromatic petroleum resins, and the resins specified above which are modified to have a functional group reactive with an active hydrogen group such as an isocyanate group.

These can be used alone or in combination.

The proportion of the solid portion in the polyester resin emulsion for toner is not particularly limited and can be suitably selected to suit to a particular application. For example, it is preferably from 5 to 50 percent by mass and more preferably from 30 to 45 percent by mass.

When the solid content concentration in the polyester resin emulsion for toner is 5 percent by mass or more, the aggregation efficiency of shell particles to core particles is improved, thereby enhancing the productivity of the toner, making it suitable.

A solid content concentration in the polyester resin emulsion for toner of 50 or less percent by mass enhances the emulsion stability, making it suitable.

The method of measuring the solid content concentration in the polyester resin emulsion for toner is not particularly restricted and can be selected appropriately according to the purpose. For example, it can be determined by drying the emulsion sample weighed on an aluminum cup in a constant temperature bath set at 150 degrees Celsius for 3 hours and weighing the emulsion sample before and after drying.

As will be described in detail later, the polyester resin emulsion for toner is preferably for use in shell-forming in manufacturing the toner with a core-shell structure of core particles containing a binder resin and a shell covering the core particles.

### Method of Manufacturing Polyester Resin Emulsion for Toner

The method of manufacturing the polyester resin emulsion for toner is not particularly restricted and can be chosen as appropriate according to the purpose. For example, methods such as shear emulsification, phase inversion emulsification, and other known dispersion methods can be employed.

As an example of the shear emulsification method, the polyester resin A dissolved in an organic solvent is added to an aqueous medium, followed by dispersing with such mechanical shear forces as low-speed shear, high-speed shear, frictional shear, high-pressure jet, ultrasonic homomixer, homogenizer, ball mill with media, sand mill, and Dyno mill.

An example of the phase inversion emulsification method involves dissolving the polyester resin A in an organic solvent and then adding an aqueous medium to induce phase inversion.

Of these methods, the phase inversion emulsification method is preferred for producing emulsions that are homogeneous with sharp particle size distribution.

### Phase Inversion Emulsification

The phase inversion emulsification method involves adding an aqueous medium to the resin solution obtained by dissolving the polyester resin A in an organic solvent to induce phase inversion.

### Organic Solvent

The organic solvent used in the phase inversion emulsification method is not particularly restricted and can be chosen appropriately according to the purpose. For example, ethanol, isopropanol, isobutanol, acetone, methyl ethyl ketone, methyl isobutyl ketone, diethyl ketone, dibutyl ether, tetrahydrofuran, dioxane, methyl acetate, ethyl acetate, isopropyl acetate, toluene, xylene, benzene, carbon tetrachloride, methylene chloride, 1,2-dichloroethane, 1,1,2-trichloroethane, trichloroethylene, chloroform, monochlorobenzene, and dichloroethylene, can be listed.

Among these, methyl ethyl ketone, ethyl acetate, and isopropyl acetate are preferable from the perspectives of solvent removal efficiency and solubility of polyester resin.

These can be used alone or in combination.

It is preferable that the emulsion consisting of the aforementioned resin solution and the aqueous medium preferably be rapidly purged of the organic solvents from the perspective of dispersion stability. There are no particular restrictions on the methods of removing the organic solvent, and a known solvent removal method can be selected depending on the purpose. It includes, for example, a method of gradually heating the emulsion with stirring to evaporate the organic solvents within the system, a method of spraying the emulsion while stirring into a dry atmosphere such as air or nitrogen to remove the organic solvents within the system, and a method of reducing the pressure while stirring the emulsion to evaporate the organic solvents within the system.

These can be used alone or in combination.

### Aqueous Medium

The aqueous medium used in the phase inversion emulsification method is not particularly restricted and can be appropriately selected depending on the purpose. For example, water or mixtures of water with organic solvents miscible with water can be used.

There are no specific restrictions on the content of the aqueous medium, and it can be selected appropriately depending on the purpose. The amount of the aqueous medium is preferably 80 to 150 parts by mass per 100 parts by mass of the resin solution.

In the phase inversion emulsification method, there are no specific restrictions on the rate of addition of the aqueous medium from the beginning of phase inversion of the resin solution until its completion. It can be selected appropriately depending on the purpose. Preferably, the rate of addition is 0.1 to 60 parts by mass per minute per 100 parts by mass of the resin solution, and more preferably 1 to 3 parts by mass per minute.

A rate of addition of the aqueous medium of 0.1 or more parts by mass per minute to 100 parts by mass of the resin solution is preferable to improve the productivity of toner.

When the rate of addition of the aqueous medium is 60 parts by mass per minute to 100 parts by mass of the resin solution, it is preferable to achieve a sharp particle size distribution and good aggregation of shell particles with core particles, thus allowing for the formation of a uniform shell.

In the phase inversion emulsification method, additives such as neutralizing agents, surfactants, and polymer protection colloids can be added to the resin solution or aqueous medium without an adverse impact on the effects of the present disclosure.

### Neutralizing Agent

The neutralizing agent is not particularly limited and can be suitably selected to suit to a particular application. One such example is a basic substance.

Specific examples of such basic substances include, but are not limited to, ammonia, trimethylamine, ethylamine, diethylamine, triethylamine, diethanolamine, triethanolamine, tributylamine, lithium hydroxide, sodium hydroxide, and potassium hydroxide.

Among these, ammonia and sodium hydroxide are preferably used to ensure the quality of the emulsion.

The degree of neutralization r, which is the molar ratio of the neutralizing agent to the acid value AV of the polyester resin A, can be selected appropriately depending on the purpose without specific restrictions. It is preferable for the degree of neutralization to be 30 to 150 percent, with more preferable values ranging from 60 to 100 percent.

When the degree of neutralization r is at least 30 percent, it is suitable to promote phase inversion emulsification, resulting in the formation of uniform particle size emulsions.

When the degree of neutralization r is at most 150 percent, it is suitable to facilitate phase inversion emulsification.

The amount of neutralizing agent used is not particularly restricted and can be appropriately selected depending on the purpose. For example, it can be determined by the following equation 1. In the equation below, AV represents the acid value of the resin (mg KOH/g), M represents the amount of resin used (g), and r represents the degree of neutralization (percent).

$$Amount of neutralizing agent used ( mol / g ) = ( AV / 56.11 ) \times M \times ( r / 100 ) \qquad Equation 1$$

### Surfactant

The choice of the surfactant is not particularly restricted and can be appropriately selected depending on the purpose.

Specific examples include, but are not limited to, anionic surfactants such as alkylbenzene sulfonates, alpha-olefin sulfonates, and phosphate esters; amine salt types such as alkylamine salts, aminoalcohol fatty acid derivatives, polyamine fatty acid derivatives, and imidazolines; cationic surfactants such as alkyltrimethylammonium salts, dialkyldimethylammonium salts, alkylbenzyldimethylammonium salts, pyridinium salts, alkylisoquinolinium salts, and benzethonium chloride; nonionic surfactants such as fatty acid amide derivatives and polyhydric alcohol derivatives; and alanine, dodecyl dimethyl glycine, di(octylaminoethyl) glycine, and N-alkyl-N,N-dimethylammonium betaines.

### Polymer Protection Colloid

The polymer protection colloids are not particularly limited and can be suitably selected to suit to a particular application.

Specific examples include, but are not limited to, polymers and copolymers prepared using monomers, for example, acids (e.g., acrylic acid, methacrylic acid, α-cyanoacrylic acid, α-cyanomethacrylic acid, itaconic acid, crotonic acid, fumaric acid, maleic acid, and maleic anhydride), (meth)acrylic monomers having a hydroxyl group (e.g., β-hydroxyethyl acrylate, β-hydroxyethyl methacrylate, β-hydroxypropyl acrylate, β-hydroxypropyl methacrylate, γ-hydroxypropyl acrylate, γ-hydroxypropyl methacrylate, 3-chloro-2-hydroxypropyl acrylate, 3-chloro-2-hydroxypropyl methacrylate, diethylene glycolmonoacrylic acid esters, diethylene glycolmonomethacrylic acid esters, glycerinmonoacrylic acid esters, N-methylolacrylamide and N-methylolmethacrylamide); vinyl alcohol and its ethers (e.g., vinyl methyl ether, vinyl ethyl ether and vinyl propyl ether), esters of vinyl alcohol with a compound having a carboxyl group (i.e., vinyl acetate, vinyl propionate and vinyl butyrate); acrylic amides (e.g, acrylamide, methacrylamide, and diacetoneacrylamide) and their methylol compounds, acid chlorides (e.g., acrylic acid chloride and methacrylic acid chloride); monomers having a nitrogen atom or a heterocyclic ring having a nitrogen atom (e.g., vinyl pyridine, vinyl pyrrolidone, vinyl imidazole, and ethylene imine); polyoxyethylene compounds (e.g., polyoxyethylene, polyoxypropylene, polyoxy ethylene alkyl amines, polyoxypropylene alkyl amines, polyoxy ethylenealkyl amides, polyoxypropylene alkyl amides, polyoxyethylene nonylphenyl ethers, polyoxyethylene lauryl phenyl ethers, polyoxyethylene stearylphenyl esters, and polyoxyethylene nonylphenyl esters), and cellulose compounds, for example, methyl cellulose, hydroxyethyl cellulose, and hydroxy propyl cellulose.

### Resin Particle T and Toner

The resin particle T of the present disclosure has a core-shell structure including a core particle containing a binder resin and a shell particle covering the core particle, the shell particle being formed from a polyester resin emulsion for toner. The resin particle T may optionally contain additives and other components.

The toner of the present disclosure is a toner having a core-shell structure including a core particle containing a binder resin and a shell particle covering the core particle, the shell particle being formed from the toner polyester resin emulsion in the present disclosure. The toner may optionally contain additives and other components.

It should be noted that the “polyester resin emulsion for toner” is the same as described in the item “Polyester Resin Emulsion for Toner” above, so further explanation is omitted.

Furthermore, the resin particle S contained in the polyester resin emulsion for toner and the resin particle T containing the polyester resin emulsion for toner are different.

### Core-Shell Structure

The core-shell structure, for example, may denote a structure 1 where resin particles forming the shell are distributed on the outermost surface of core particles containing a binder resin, thereby covering the surface of the core particles, or a structure 2 where a resin-based shell layer is formed on the outermost surface of core particles containing a binder resin, also covering the surface of the core particles.

In the present disclosure, the term “shell layer” refers to a shell portion in which particles have undergone heat treatment, causing the shell particles to fuse together, resulting in an indistinct boundary between individual particles in the structure 1 mentioned above.

Of the two, the structure 2 is preferable, which offers superior homogeneity, heat resistance, and mechanical durability of the toner, with the added advantage of the shell layer being less prone to detachment due to stress.

In the present disclosure, the shell portion in the core-shell structures 1 and 2 are also referred to as “shell”.

In the resin particles T and toner with a core-shell structure, it may not be necessary for the surface of the core particles to be completely covered by the shell, the coverage area is preferably 90 or more percent of the total surface area of the core particles to achieve toner homogeneity, heat resistance, and mechanical durability.

### Core Particle

The core particles contain a binder resin and may optionally include crystalline resins as fixing aids, colorants, release agents, and charge control agents.

### Binder Resin

There is no specific limitation on the binder resin and it can be suitably selected to suit to a particular application.

Specific examples include, but are not limited to, styrene polymers and substituted styrene polymers such as polystyrene, poly-p-styrene, and polyvinyltoluene; styrene copolymers such as styrene-p-chlorostyrene copolymers, styrene-propylene copolymers, styrene-vinyltoluene copolymers, styrene-methyl acrylate copolymers, styrene-ethyl acrylate copolymers, styrene-methacrylate copolymers, styrene-methyl methacrylate copolymers, styrene-ethyl methacrylate copolymers, styrene-butyl methacrylate copolymers, styrene-α-methyl chloromethacrylate copolymers, styrene-acrylonitrile copolymers, styrene-vinyl methyl ether copolymers, styrene-vinyl methyl ketone copolymers, styrene-butadiene copolymers, styrene-isopropyl copolymers, and styrene-maleic acid ester copolymers; and other resins such as polymethyl methacrylate, polybutyl methacrylate, polyvinyl chloride, polyvinyl acetate, polyethylene, polyesters, epoxy resins, polyurethane resins, polyvinyl butyral resins, polyacrylic resins, rosin, modified rosins, terpene resins, phenol resins, aliphatic or aromatic hydrocarbon resins, aromatic petroleum resins, and the resins specified above which are modified to have a functional group reactive with an active hydrogen group.

These can be used alone or in combination.

The binder resin is preferably supplemented with at least one type of amorphous polyester resin B to enhance adhesion of the core particle to the shell and improve the toner's mechanical durability. There are no specific restrictions regarding the polyester resin in the amorphous polyester resin B, and it can be appropriately selected depending on the purpose. For instance, the same types of polyester resin as those described in the polyester resin A section above can be utilized.

### Crystalline Resin

The crystalline resin is not particularly limited and can be suitably selected to suit to a particular application as long as it has crystallinity. Examples include, but are not limited to, polyester resin, polyurethane resin, polyurea resin, polyamide resin, polyether resin, vinyl resin, and modified crystalline resin. Among these, polyester resin is preferred for its excellent combination of low-temperature fixing capability and heat resistance.

These can be used alone or in combination.

The crystalline resin is preferably melted near the fixing temperature of the toner. Including this crystalline resin in the toner is preferable and ensures that it melts at the fixing temperature and becomes compatible with the binder resin, thereby enhancing the toner's sharp melting and providing excellent low-temperature fixing capability.

There are no specific restrictions on the melting point of the crystalline resin. It is preferably between 60 degrees Celsius and 100 degrees Celsius.

A melting point of the crystalline resin of at least 60 degrees Celsius facilitates its melting at low temperatures, ensuring good heat resistance of the toner.

When the melting point of the crystalline resin is at or below 100 degrees Celsius, it is suitable to improve the toner's low-temperature fixability.

### Colorant

The colorant has no particular limitation and can be suitably selected to suit to a particular application.

Specific examples include, but are not limited to, carbon black, Nigrosine dyes, black iron oxide, Naphthol Yellow S, Hansa Yellow (10G, 5G and G), Cadmium Yellow, yellow iron oxide, loess, chrome yellow, Titan Yellow, polyazo yellow, Oil Yellow, Hansa Yellow (GR, A, RN and R), Pigment Yellow L, Benzidine Yellow (G and GR), Permanent Yellow (NCG), Vulcan Fast Yellow (5G and R), Tartrazine Lake, Quinoline Yellow Lake, Anthrazane Yellow BGL, isoindolinone yellow, red iron oxide, red lead, orange lead, cadmium red, cadmium mercury red, antimony orange, Permanent Red 4R, Para Red, Fire Red, p-chloro-o-nitroaniline red, Lithol Fast Scarlet G, Brilliant Fast Scarlet, Brilliant Carmine BS, Permanent Red (F2R, F4R, FRL, FRLL and F4RH), Fast Scarlet VD, Vulcan Fast Rubine B, Brilliant Scarlet G, Lithol Rubine GX, Permanent Red F5R, Brilliant Carmine 6B, Pigment Scarlet 3B, Bordeaux 5B, Toluidine Maroon, Permanent Bordeaux F2K, Helio Bordeaux BL, Bordeaux 10B, BON Maroon Light, BON Maroon Medium, Eosin Lake, Rhodamine Lake B, Rhodamine Lake Y, Alizarine Lake, Thioindigo Red B, Thioindigo Maroon, Oil Red, Quinacridone Red, Pyrazolone Red, polyazo red, Chrome Vermilion, Benzidine Orange, perynone orange, Oil Orange, cobalt blue, cerulean blue, Alkali Blue Lake, Peacock Blue Lake, Victoria Blue Lake, metal-free Phthalocyanine Blue, Phthalocyanine Blue, Fast Sky Blue, Indanthrene Blue (RS and BC), Indigo, ultramarine, Prussian blue, Anthraquinone Blue, Fast Violet B, Methyl Violet Lake, cobalt violet, manganese violet, dioxane violet, Anthraquinone Violet, Chrome Green, zinc green, chromium oxide, viridian, emerald green, Pigment Green B, Naphthol Green B, Green Gold, Acid Green Lake, Malachite Green Lake, Phthalocyanine Green, Anthraquinone Green, titanium oxide, zinc oxide, and lithopone.

These can be used alone or in combination.

The content of the colorant is not particularly restricted and can be appropriately selected depending on the purpose. It is preferable that the content of the colorant is from 1 to 15 percent by mass of the total amount of the resin particles T or the total amount of the toner, and more preferably from 3 to 10 percent by mass.

When the content of the colorant is at least 1 percent by mass of the total amount of the resin particles T or the total amount of the toner, the coloring power of the toner is improved, making it suitable.

A content of the colorant of 15 or less percent by mass of the total amount of the resin particles T or the total amount of the toner exhibits good dispersion state of the pigment in the toner, leading to good coloring power and charging properties of the toner, making it suitable.

The colorant and the resin for master batch can be used in combination as a master batch.

There is no specific limitation to the resin for master batch and it can be suitably selected to suit to a particular application.

Specific examples thereof include, but are not limited to, styrene or substituted polymers thereof, styrene-based copolymers, polymethyl methacrylate resins, polybutyl methacrylate resins, polyvinyl chloride resins, polyvinyl acetate resins, polyethylene resins, polypropylene resins, polyesters resins, epoxy resins, epoxy polyol resins, polyurethane resins, polyamide resins, polyvinyl butyral resins, polyacrylic resins, rosin, modified rosins, terpene resins, aliphatic hydrocarbon resins, alicyclic hydrocarbon resins, aromatic petroleum resins, chlorinated paraffin, and paraffin.

These can be used alone or in combination.

### Release Agent

The release agent is not particularly limited and can be suitably selected to suit to a particular application.

Specific examples include, but are not limited to, carnauba wax, rice wax, montan wax, trimethylol propane tribehenate, pentaerythrityl tetrabehenate, pentaerythrityl diacetate dibehenates, glyceryl tribehenate, stearyl icosenoate, behenyl eicosylate, behenyl behenate, stearyl behenate, phenyl behenate, and stearyl stearate, among alkanic acid esters; polyalcohol esters such as trimellitic acid tristearate, and distearyl maleate; polyalkanoic acid amides such as dibehenylamide; polyalkyl amides such as trimellitic acid and tristearlyl amide; dialkyl ketones such as distearyl ketone; polyolefin waxes such as polyethylene wax, and polypropylene wax; and wax types such as paraffin wax, microcrystalline wax, and Sazol wax, which are long-chain hydrocarbons. Among these, wax types of alkanic acid esters are preferable.

These can be used alone or in combination.

There is no specific limit to the melting point of the release agent. The melting point is preferably from 40 to 160 degrees Celsius, more preferably from 50 to 120 degrees Celsius, and particularly preferably from 60 to 90 degrees Celsius.

A melting point of the release agent of at least 40 degrees Celsius is suitable for stable storage in a high temperature environment.

When the melting point of the release agent is at 160 degrees Celsius or below, the occurrence of cold offset during low-temperature fixing occurs less frequently, which is preferable.

The content of the release agent is not particularly limited and can be suitably selected to suit to a particular application. It is preferably 1 to 20 parts by mass to the entire mass of the resin particles T or the toner as a whole, more preferably 3 to 15 percent by mass, and even more preferably 3 to 7 parts by mass.

When the content of the release agent is at most 20 percent by mass to the total amount of the resin particles T or the total amount of the toner, the toner exhibits good flowability, which is advantageous.

### Charge Control Agent

There is no specific limitation to the selection of the charge control agent and it can be suitably selected to suit to a particular application.

Specific examples include, but are not limited to, nigrosine dyes, triphenylmethane dyes, chrome containing metal complexes, chelate compounds of molybdic acid, Rhodamine dyes, alkoxyamines, quaternary ammonium salts, alkylamides, phosphor and compounds including phosphor, tungsten and compounds including tungsten, fluorine-containing activators, metal salts of salicylic acid and metal salts of salicylic acid derivatives.

The proportion of the charge control agent is not particularly limited and can be suitably selected to suit to a particular application. The number of parts of the release agent is preferably from 0.1 to 10 parts by mass and more preferably from 0.2 to 5 parts by mass to 100 parts of the resin particles T or the toner.

A content of the charge controlling agent of 10 or less parts by mass per 100 parts by mass of the resin particles T or the toner is preferable to improve the charging properties of the toner, thereby minimizing the decrease in developer fluidity and image density.

### Volume Average Particle Diameter Dv of Core Particle

The volume average particle diameter Dv of the core particles is not particularly restricted and can be appropriately selected depending on the purpose. It is preferable for the median diameter D50 to be from 4 to 7 μm to enhance particle size distribution, sharpness, and fine line reproducibility.

The method of measuring the median diameter D50 is not particularly limited and can be suitably selected to suit to a particular application. One way of measuring is to use a laser diffraction particle size analyzer LA-920 (available from HORIBA, Ltd.).

### Average Circularity of Core Particle

The average circularity of the core particles is not particularly restricted and can be appropriately selected depending on the purpose. It is preferable for the circularity to be from 0.940 to 0.990 to enhance transfer efficiency, fine line reproducibility, and cleaning properties of toner residues on image bearers or transfer belts.

There are no specific restrictions on the method for measuring the average circularity of the core particles, and it can be appropriately selected depending on the purpose. The average circularity can be measured using equipment such as a flow-type particle image analyzer FPIA-3000 (available from Sysmex Corporation).

The method of manufacturing the core particles is not particularly restricted and can be appropriately selected depending on the purpose. For example, methods such as kneading pulverization and granulating particles in an aqueous medium, known as the so-called chemical method, can be used.

Specific examples of the chemical methods of granulating toner particles in an aqueous medium include, but are not limited to: suspension polymerization methods, emulsion polymerization methods, seed polymerization methods, and dispersion polymerization methods using a monomer as the starting material; dissolution suspension methods, where a resin or resin precursor is dissolved in an organic solvent and then dispersed and/or emulsified in an aqueous medium; phase inversion emulsification methods, where water is added to a solution containing a resin or resin precursor and a suitable emulsifier to induce phase inversion; and aggregation methods, where particles obtained by these methods are dispersed in an aqueous medium and then aggregated and granulated by processes such as heating and melting to achieve the desired particle size.

Among these, the dissolution suspension method, phase inversion emulsification method, and aggregation method are preferable for easily handling polyester resins with excellent low-temperature fixability.

The core particles are preferably aqueous dispersions for aggregating with the toner polyester resin emulsion, and more preferably, these aqueous dispersions are obtained through chemical methods.

In the case of core particles obtained through the kneading pulverization method mentioned earlier, it is preferable to use core particles that have undergone sphericalization treatment and surface smoothing treatment by, for example, heating to form a uniform shell.

Core particles without any substances added such as additives and flowability improvers are preferable to aggregate shell particles on the surface of the core particles.

### Shell

The shell can be obtained by subjecting a polyester resin emulsion containing resin particles S that form the shell to a process of aggregating onto the outermost surface of the core particles, followed by heating and fusing.

The core particle and the shell are preferably in a state where they adhere to each other, or in a state where they are not completely miscible with each other, with regions consisting only of the core particle or shell.

The average thickness of the shell has no particular limit and can be suitably selected to suit to a particular application. For example, it is preferably from 50 to 500 nm and more preferably from 100 to 200 nm.

An average thickness of the shell at or above 50 nm enhances the protective function on the core particles, leading to improved heat resistance and mechanical durability, making it preferable.

On the other hand, with an average thickness of the shell at or below 500 nm, it becomes preferable for good low-temperature fixability.

There are no specific restrictions on the method of measuring the average thickness of the shell, and it can be chosen appropriately according to the purpose. One such method involves measuring using a transmission electron microscope (TEM) an ultrathinly sectioned material obtained by sectioning a sample of toner particles embedded in such a substance as epoxy resin with a microtome or ultramicrotome. In some cases, staining ultrathin sections with staining agents such as ruthenium tetroxide or osmium tetroxide makes the core-shell structure more visible, which is advantageous. One specific method is as follows.

A sample of toner particles embedded in such a substance as epoxy resin is sectioned into ultrathin slices using an ultramicrotome. Its cross-section image is captured at a factor of 20,000 magnification using a transmission electron microscope (TEM) (JEM-2100F, available from JEOL Ltd.). The captured image is then imported into an image analysis device (LuzeX AP/available from Nileco), where the thickness of the shell is measured at five points for each of the 30 toner particles. The average thickness is then calculated from these measurements.

The volume average particle diameters Dv of the resin particles T and the toner are not particularly limited and they can be suitably selected to suit to a particular application. They are preferably from 3 to 10 μm, with 4 to 7 μm being more preferable, to produce high-quality images with excellent particle size distribution, sharpness, and fine line reproduction.

A volume average particle diameter Dv of the resin particles T and the toner at or above 3 μm is suitable to achieve good toner fluidity and transferability.

The ratio (Dv/Dn) of the volume average particle diameter Dv of the resin particles T and the toner to the number average molecular weight Dn of the resin particles T and the toner represents the particle size distribution of the resin particles T and the toner, with values closer to 1 indicating a sharp particle size distribution.

This ratio (Dv/Dn) is preferably 1.20 or less, with values of 1.15 or less being more preferable to enhance sharpness and fine line reproduction.

There are no particular restrictions on the method of measuring the volume average particle diameter Dv and number average molecular weight Dn of the resin particles T and the toner. It can be measured using, for example, a Coulter Multisizer III (aperture diameter 100 μm) (available from Beckman Coulter).

The average circularities of the resin particles T and the toner are not particularly limited and can be suitably selected according to the purpose. It is preferable to be from 0.940 to 0.990. Additionally, it is more preferable that the proportion of the resin particles (T) and the toner with an average circularity of from 0.960 to 0.985 and an average circularity below 0.940 is 15 or less percent by mass of the total amount of the resin particles (T) and the toner.

Toner with circularity within the above range, i.e., substantially spherical toner, is effective in achieving excellent transfer efficiency, forming high-resolution images with moderate density and reproducibility. Moreover, fine line images with less transfer voids can be obtained. This is because the smooth surface of the toner reduces contact points with the image bearer, decreasing toner voids and transfer defects to transfer materials.

When the average circularity of the resin particles T and the toner is 0.940 or above, it is preferable to achieve good transferability.

When the average circularity of the resin particles T and the toner is 0.990 or below, it is preferable for systems employing blade cleaning to solve an issue of poor cleaning that may occur on the photoconductor and transfer belt, resulting in image dirt. For instance, in low image area ratio development or transfer, transfer residual toner is minimal and cleaning issues are less problematic. However, in high image area ratio cases such as color photo images, or when there are issues like paper feeding failures, untransferred toner used for image formation may remain on the image bearer as transfer residual toner, accumulating thereon and causing background fouling. Furthermore, problems may arise with contamination of the charging roller and other charging devices, leading to a decrease in their original charging capacity. The present disclosure can resolve these issues effectively.

There are no specific restrictions on the method for measuring the average circularity of the toner, and it can be appropriately selected depending on the purpose. The average circularity can be measured using equipment such as a flow-type particle image analyzer FPIA-3000 (available from Sysmex Corporation).

There are no specific restrictions on the method for measuring the average circularity of the resin particle T and the toner, and it can be appropriately selected depending on the purpose. The average circularity can be measured using equipment such as a flow-type particle image analyzer FPIA-3000 (available from Sysmex Corporation). Specifically, the circularity of each particle is calculated from the two-dimensional image area of each particle captured by a charge coupled diode (CCD) camera. The circularity of each particle is then summed, and the sum is divided by the total number of particles to obtain the average circularity. The circularity of each particle can be calculated by dividing the perimeter of a circle with the same projected area as the particle image by the perimeter of the particle's projected image.

### External Additive

There are no specific restrictions on the external additives, and they can be suitably chosen according to the purpose. Examples include, but are not limited to, inorganic particles, polymer-based particles, flow improver, and cleaning improvers.

### Inorganic Fine Particle

Specific examples of such inorganic fine particles include, but are not limited to, silica, alumina, titanium oxide, barium titanate, magnesium titanate, calcium titanate, strontium titanate, zinc oxide, tin oxide, quartz sand, clay, mica, sand-lime, diatom earth, chromium oxide, cerium oxide, red iron oxide, antimony trioxide, magnesium oxide, zirconium oxide, barium sulfate, barium carbonate, calcium carbonate, silicon carbide, and silicon nitride.

The primary particle diameter of the inorganic fine particle is not particularly limited and can be suitably selected to suit to a particular application. For example, it is preferably from 5 nm to 2 μm and more preferably from 5 to 500 nm.

When the primary particle diameter of the inorganic particles is at or above 5 nm, it is preferable to minimize its embedding into the surface of toner particles caused by mechanical stress. When the primary particle diameter of the inorganic particles is at or below 2 μm, it is preferable to minimize detachment from toner particles.

In addition, the specific surface area of such inorganic particulates measured by a BET method is preferably between 20 m²/g to 500 m²/g.

The content of the inorganic fine particles is preferably from 0.01 to 5 percent by mass to the total amount of resin particles T and toner.

### Polymer Fine Particle

The polymer fine particles include, but are not limited to, polystyrene, methacrylates, and acrylates obtained by soap-free emulsion polymerization, suspension polymerization, or dispersion polymerization, and polycondensed particles such as silicone, benzoguanamine, and nylon, and polymer particles of thermocuring resin.

### Flow Improver

There is no particular limitation to the flow improver mentioned above, and it can be suitably selected for a specific application as long as it can be surface-treated to become more hydrophobic, thus maintaining fluidity and chargeability even in a highly humid environment.

Specific examples include, but are not limited to, silane coupling agents, silylating agents, silane coupling agents including an alkyl fluoride group, organic titanate coupling agents, aluminum-containing coupling agents, silicone oil, and modified silicone oil.

The silica and titanium dioxide as the inorganic particles mentioned above are preferably hydrophobized by the flowability improver to be used as hydrophobic silica and hydrophobic titanium dioxide.

### Cleaning Property Improver

The cleaning property improver is not particular limited as long as it can be added to the toner to remove the developing agent remaining on the image bearer (photoconductor) or a primary intermediate transfer element after image transfer.

Specific examples include, but are not limited to, metal salts of fatty acid including stearic acid, zinc stearate, calcium stearate, and polymer fine particles such as polymethyl methacrylate fine particles and polystyrene fine particles, which are prepared by a soap-free emulsion polymerization method.

The polymer fine particles preferably have a relatively sharp particle size distribution and its volume average particle diameter is preferably from 0.01 to 1 μm.

The external additive aforementioned is attached to the particle surface by mixing with the resin particles T and the toner.

There are no particular restrictions on the methods of mixing mentioned above. For example, methods include applying impact force to the mixture by blades rotating at high speed, and introducing the mixture into a high-speed airflow to collide particles or composite particles with a suitable collision plate in an accelerated manner.

Specific examples of such mixing devices include, but are not limited to, ONG MILL (available from Hosokawa Micron Co., Ltd.), modified I TYPE MILL (available from Nippon Pneumatic Mfg. Co., Ltd.) in which the pressure of pulverization air is reduced, HYBRIDIZATION SYSTEM (available from Nara Machine Co., Ltd.), KRYPTRON SYSTEM (available from Kawasaki Heavy Industries, Ltd.), and automatic mortars.

Method of Manufacturing Resin Particle T with Core-shell Structure and Toner Methods of manufacturing the resin particles T and toner are not particularly limited. It may include aggregation processes and fusion processes, along with other optional processes such as rinsing, drying, and annealing.

### Aggregation Process

The aggregation process involves adding shell particles to a liquid dispersion of core particles in an aqueous medium and agitating to aggregate shell particles onto the surface of the core particles.

The aggregation process may be conducted during heating.

The temperature of the aqueous medium in the aggregation process is not particularly limited, and it can be selected appropriately depending on the purpose. For efficient aggregation, the temperature is preferably at or above 20 degrees Celsius, and not higher than the glass transition temperature Tg of the polyester resin A.

To facilitate the aggregation process, it is permissible to add an aggregating agent or adjust pH.

The aggregating agent is not particularly limited and can be appropriately selected depending on the purpose.

Specific examples include, but are not limited to, aluminum chloride, zinc sulfate, magnesium sulfate, aluminum sulfate, potassium aluminum sulfate, sodium chloride, sodium bromide, sodium iodide, sodium fluoride, sodium acetate, sodium acetate, lithium chloride, lithium bromide, lithium iodide, lithium fluoride, lithium acetate, lithium acetate, potassium chloride, potassium bromide, potassium iodide, potassium fluoride, potassium acetate, magnesium bromide, magnesium chloride, magnesium iodide, magnesium fluoride, magnesium acetate, magnesium acetate, calcium chloride, calcium bromide, barium bromide, barium chloride, barium iodide, barium fluoride, barium acetate, barium acetate, strontium bromide, strontium chloride, strontium iodide, strontium fluoride, strontium acetate, strontium acetate, zinc bromide, zinc chloride, zinc iodide, zinc fluoride, zinc acetate, zinc acetate, copper bromide, copper chloride, copper iodide, copper fluoride, copper acetate, copper acetate, iron bromide, iron chloride, iron iodide, iron fluoride, iron acetate, and iron acetate.

These can be used alone or in combination.

The proportion of the aggregating agent is not particularly limited and can be suitably selected to suit to a particular application. The number of parts of the aggregating agent is preferably from 0.1 to 20 parts by mass and more preferably from 0.5 to 10 parts by mass to 100 parts by mass of the core particle and shell particles mentioned above.

Using the aggregating agent as an aqueous solution is preferable to achieve uniform aggregation within the reaction system. When using the aggregating agent as an aqueous solution, it is preferable that the content of the aggregating agent be 1 to 50 percent by mass of the total amount of the aqueous solution, more preferably 5 to 20 mass percent.

The rate of adding the aggregates to the aqueous medium is not particularly limited, but a rate of 0.1 parts by mass per minute to 5 parts by mass per minute relative to 100 parts by mass of the aqueous medium is preferable, with 0.5 parts by mass per minute to 2 parts by mass per minute being more preferable.

The aggregation reaction in the aggregation process can be halted as necessary. Methods of ceasing aggregation are not particularly limited. They include a method of adding salts with low valency, chelating agents, or surfactants, a method of adjusting pH, a method of lowering the temperature of a liquid dispersion, or a method of diluting the concentration by adding a large amount of aqueous medium.

Specific examples of the chelating agents include, but are not limited to, metal salts such as sodium ethylenediaminetetra acetate, sodium gluconate, sodium tartrate, sodium citrate, potassium citrate, and nitrotriacetate salts, as well as polymer electrolytes.

### Fusion Process

In the fusion process, the aggregated particles, containing core particles and shell particles obtained in the aggregation process, are heated and fused to form a shell on the surface of the core particle.

It is preferable to heat the liquid dispersion of the aggregated particles during stirring in the fusion process.

There is no particular limit to the temperature in the fusion process. Preferably, the temperature is at least the glass transition temperature Tg of the polyester resin A.

### Rinsing Process

In the aforementioned rinsing process, the resin particles T or toner obtained by the fusion process are rinsed.

There are no particular restrictions on the method of cleaning in this rinsing process, and it can be selected appropriately depending on the purpose. Examples include centrifugation, vacuum filtration, and filter press methods.

If the resin particles T or toner is not sufficiently rinsed in one operation, the cake obtained from this rinsing process can be dispersed again into an aqueous solvent to form a slurry, and the process of extracting resin particles T or toner using any of the above methods may be repeated. Furthermore, in the case of vacuum filtration or filter press methods, it is also acceptable to conduct washing by allowing the aqueous solvent to penetrate the cake.

As for the aqueous solvent used for this rinsing, there are no particular restrictions. Examples include water or mixed solvents such as water mixed with methanol, ethanol, or other alcohols. Among these, water is preferable considering the cost and environmental burden caused by wastewater treatment.

### Drying

The aforementioned drying process is a step to dry the cake obtained from the rinsing process.

There are no particular restrictions on the drying method in this drying process, and it can be appropriately selected depending on the purpose. Examples include, but are not limited to, spray dryers, vacuum freeze dryers, vacuum dryers, static shelf dryers, mobile shelf dryers, fluidized bed dryers, rotary dryers, agitated dryers, and other drying machines.

It is preferable for the drying to continue until the moisture content in the cake is less than one percent. Furthermore, the resin particles T and toner obtained after drying may be pulverized using devices such as jet mills, Henschel mixers, super mixers, coffee mills, Oster blenders, or food processors to break up aggregates.

### Annealing

Annealing is preferably conducted for the core particles containing crystalline polyester resin.

Annealing is preferably conducted at a temperature at or above the glass transition temperature and at or below the melting point of the crystalline polyester resin. Additionally, the annealing time is preferably conducted for a period of at least 3 hours and up to 24 hours, with more preference of from 6 to 15 hours.

### Developing Agent

The toner of the present disclosure can be used as a developing agent containing appropriately selected optional components such as carrier.

The developing agent such as a one-component developing agent and a two-component developing agent can be used and the two-component developing agent is preferable in terms of life length thereof particularly when used in a high speed printer that meets the demand of high speed information processing speed of late.

In a case where a one-component developing agent using the toner described above is used and replenished, i.e., the supply of toner to the developer and the consumption of toner due to development, the variation in the particle diameter of the toner is small, no filming of the toner on the developing roller occurs, and no fusion bonding of the toner onto members such as a blade for regulating the thickness of the toner layer occurs. Consequently, good and stable development performance and image quality can be achieved even during long-term use (stirring) of the developing device.

In a case of a two-component developing agent using the toner described above, extended toner replenishment over time does not significantly alter the particle size of the toner in the developing agent, which leads to excellent and stable charging and development performance during long-term agitation in the developing device.

There is no specific limitation to the carrier and it can be suitably selected to suit to a particular application. It is preferable to use a carrier particle that has a core material and a resin layer covering the core material.

There is no specific limitation to the material for the core material and it can be suitably selected to suit to a particular application. For example, manganese-strontium (Mn—Sr) based material and manganese-magnesium (Mn—Mg) based material having 50 to 90 emu/g are preferable. To ensure the image density, highly magnetized materials such as powdered iron having 100 emu/g or more and magnetite having 75 to 120 emu/g are preferable. In addition, weakly magnetized copper-zinc (Cu—Zn) based materials having 30 emu/g to 80 emu/g are preferable to reduce the impact of the contact between the toner filaments formed on the development roller and the latent electrostatic image bearer, which is advantageous in improvement of the image quality.

These can be used alone or in combination.

The core material preferably has an average particle diameter (weight average particle diameter D50) of from 10 to 200 μm and more preferably from 40 to 100 μm.

An average particle size (weight average particle size D50) of at least 10 μm is preferable to effectively resolve issues such as an increase in fine powder in the carrier particle distribution, resulting in reduced magnetization per particle and causing carrier scatter.

An average particle size (weight average particle size D50) is at most 200 μm is preferable to effectively address issues such as toner scatter due to decreased specific surface area, particularly affecting the reproduction of full-color prints with many solid areas, resulting in poor reproduction of solid areas.

There is no specific limitation to the selection of the material for the resin layer mentioned above and any known resin can be suitably selected to suit to a particular application.

Specific examples include, but are not limited to, amino-based resins, polyvinyl-based resins, polystyrene-based resins, polycarbonate-based resins, polyethylene resins, polyvinyl fluoride resins, polyvinylidene fluoride resins, polytrifluoroethylene resins, polyhexafluoropropylene resins, copolymers of vinylidene fluoride and acrylate monomer, copolymers of vinylidene fluoride and vinyl fluoride, fluoroterpolymers such as terpolymers of tetrafluoroethylene, fluorovinylidene, and monomer including no fluorine atom, and silicone resins. Of these, silicone resins are preferable.

These can be used alone or in combination.

There is no specific limitation to the silicone resins and any known silicone resins are suitably selected to suit to a particular application.

Specific examples include, but are not limited to, straight silicone resins formed of only organosiloxane bond; and silicone resins modified by alkyd resins, polyester resins, epoxy resins, acrylic resins, and urethane resins.

The silicone resin can be synthesized or procured. Specific examples of procurable silicone resins include, but are not limited to, KR271, KR255, and KR152, available from Shin-Etsu Chemical Co., Ltd. and SR2400, SR2406, and SR2410, available from DOW CORNING TORAY CO., LTD.

The modified silicone resin can be synthesized or procured.

Specific examples of the procurable modified silicone resins include, but are not limited to, KR206 (alkyd-modified), KR5208 (acrylic-modified), ES1001N (epoxy-modified), and KR305 (urethane-modified), all available from Shin-Etsu Chemical Co., Ltd. and SR2115 (epoxy-modified) and SR2110 (alkyd-modified), both available from DOW CORNING TORAY CO., LTD.

It is possible to use a silicone resin alone. Moreover, it is possible to use it with components such as a cross-linkable component and a charge size control component, simultaneously.

Optionally, electroconductive powder can be added to the resin layer.

Specific examples of such electroconductive powder include, but are not limited to, metal powder, carbon blacks, titanium oxide, tin oxide, and zinc oxide.

The average particle diameter of the electroconductive powder is preferably at most 1 μm to facilitate controlling the electric resistance.

The resin layer described above can be formed by, for example, dissolving the silicone resin described above in a solvent to prepare a liquid application and applying the liquid to the surface of the core described above by a known application method followed by drying and baking.

Specific examples of the known application methods include, but are not limited to, a dip coating method, a spray coating method, and a brushing method.

There is no specific limitation to the solvent and it can be suitably selected to suit to a particular application. Specific examples include, but are not limited to, toluene, xylene, methylethylketone, methylisobutyll ketone, cellosolve, and butylacetate.

There is no specific limitation to the baking. An external heating system or an internal heating system can be used. For example, a fixed electric furnace, a fluid electric furnace, a rotary electric furnace, a method of using a burner furnace, and a method of using a microwave can be suitably used.

There is no specific limit to the proportion of the polymer and it can be suitably selected to suit to a particular application. It is preferably 0.01 to 5.0 percent by mass to the total content of the resin layer.

When the content of the carrier is 0.01 or more percent by mass relative to the entire mass of the resin layer, it is preferable to enable the formation of a uniform resin layer on the surface of the core material.

When the content of the carrier is 5.0 or less percent by mass to the entire mass of the resin layer, it is preferable to effectively address issues such as an increase in the thickness of the resin layer, agglomeration of carriers, and inability to obtain uniform carrier particles.

When the developing agent described above is a two component developing agent, there is no specific limit to the content of the carrier in the two component developing agent. The content is preferably from 90 to 98 percent by mass and more preferably from 93 to 97 percent by mass to the entire mass of the two-component developing agent.

The ratio of mixing the toner with the carrier in the two component developing agent is preferably from 1 to 10.0 parts by mass based on 100 parts by mass of the carrier.

### Image Forming Apparatus and Image Forming Method

The image forming apparatus of the present disclosure is not particularly limited, and it can be suitably selected to suit to a particular application as long as the toner of the present disclosure is used. For example, it may include an latent electrostatic image bearer, a latent electrostatic image forming device, and a developing device, with other optional devices.

The image forming method of the present disclosure is not particularly limited, and it can be suitably selected to suit to a particular application as long as the toner of the present disclosure is used. For example, it may include forming latent electrostatic images, developing the latent electrostatic images, and conducting other optional processes.

### Latent Electrostatic Image Bearer

There is no specific limitation to the latent electrostatic image bearer with regard to the material, shape, structure, and size thereof, and it can be suitably selected from any known image bearers to suit to a particular application. The image bearer suitably employs a drum-like or belt-like shape. Also, an inorganic image bearer made of amorphous silicon or selenium, or an organic image bearer made of polysilane, or phthalopolymethine is suitably used.

An example of the organic photoconductor is a layered photoconductor, including layers—a charge-generation layer formed of non-metallic materials like phthalocyanines or titanyl phthalocyanines dispersed in a binder resin and a charge-transport layer formed of charge transport materials dispersed in a binder resin—stacked on a substrate such as an aluminum drum.

Another type is a single-layer photoconductor with a single-layer structure on a substrate, featuring a photosensitive layer formed of both charge-generation and charge-transport materials dispersed in a binder resin. In the single-layer photoconductor, hole transport agents and electron transport agents can be added to the photosensitive layer as charge transport materials.

Additionally, an undercoat layer may be provided between the substrate and either the charge generation layer of a multi-layer photoconductor or the photosensitive layer of a single-layer photoconductor.

The linear speed of the latent electrostatic image bearer is preferably at least 300 mm/s.

### Latent Electrostatic Image Forming Device and Latent Electrostatic Process

The latent electrostatic image forming device has no particular limitation as long as it can form a latent electrostatic image on a latent electrostatic image bearer and can be suitably selected to suit to a particular application. For example, a device including a charging member for charging the surface of a latent electrostatic image bearer and an irradiating device for irradiating the surface of the latent electrostatic image bearer imagewise is suitable.

The latent electrostatic image forming process has no particular limit as long as it can form a latent electrostatic image on the latent electrostatic image bearer and can be suitably selected to suit to a particular application. For example, the process is conducted by charging the surface of a latent electrostatic image bearer and irradiating the surface imagewise with the latent electrostatic image forming device.

### Charger and Charging

The charging device (charger) is not particularly limited and can be suitably selected to suit to a particular application. Specific examples include, but are not limited to, a known contact type charger that includes an electroconductive or semiconductive roller, brush, film, or a rubber blade, and a non-contact type charger using corona discharging such as corotron and scorotron. Of these, using a contact type charger is preferable for obtaining an image forming apparatus with reduced ozone production.

The charger may employ a roller form and any other form such as a magnetic brush and a fur brush, and can be selected according to the specification or form of an image forming apparatus.

Charging is accomplished, for instance, by applying a bias to the surface of the image bearer using the charging device.

### Irradiating Device and Irradiation

The irradiating device (irradiator) is not particularly limited and can be suitably selected to suit to a particular application as long as it can irradiate the surface of a latent electrostatic image bearer charged with the charger imagewise.

Specific examples include, but are not limited to, a photocopying optical system, a rod lens array system, a laser optical system, and a liquid crystal shutter optical system.

The light source for the irradiator has no particular limitation and can be suitably selected to suit to a particular application. Specific examples include, but are not limited to, typical luminous materials such as a fluorescent lamp, a tungsten lamp, a halogen lamp, a mercury lamp, a sodium lamp, a light emitting diode (LED), a semiconductor laser (LD), and electroluminescence (EL).

Variety of optical filters can be used as the light source for used in the irradiator to irradiate a latent electrostatic image bearer with beams of light having only a desired wavelength. It includes, but is not limited to, a sharp cut filter, a band-pass filter, a near infrared filter, a dichroic filter, a coherent filter, and a color conversion filter.

The irradiation is conducted by, for example, irradiating the surface of the latent electrostatic image bearer with the irradiator.

In the present disclosure, a dorsal irradiation system can be employed, where the latent electrostatic image bearer is irradiated from the rear side in an imagewise manner.

### Developing Device and Developing Process

The developing device is not particular limited and can be suitably selected to suit to a particular application as long as it can contain a toner for developing a latent electrostatic image formed on a latent electrostatic image bearer to form a toner image as a visible image.

The developing process has no particular limitation as long as the process develops a latent electrostatic image formed on the latent electrostatic image bearer with toner to render the image visible and can be suitably selected to suit to a particular application. For example, the developing process can be conducted by a developing device.

Preferably, the developing device includes a stirrer for triboelectrically charging toner, a magnetic field generator fixed inside, and a rotatable developing agent bearer that bears a developing agent containing the toner on its surface.

### Other Optional Device and Other Optional Process

Examples of the aforementioned other devices include, but are not limited to, transfer device, a fixing device, a cleaning device, a discharging (quenching) device, and a recycling device.

The other processes include, for example, a transfer process, a fixing process, a cleaning process, a discharging process, and a recycling process.

### Transfer Device and Transfer Process

The transfer device has no particular limit as long as it can transfer the toner image to a recording medium and can be suitably selected to suit to a particular application. For example, a transfer device is preferable which includes a primary transfer device to transfer visible images onto an intermediate transfer body to form a complex transfer image and a secondary transfer device to transfer the complex transfer image to a recording medium.

The transfer process has no particular limit as long as it can transfer a visible image onto a recording medium and can be suitably selected to suit to a particular application.

It is preferable to employ a configuration in which a visible image is primarily transferred to an intermediate transfer body and thereafter secondarily transferred to a recording medium.

The transfer process can be performed by, for example, charging the latent electrostatic image bearer (photoconductor) with a transfer charging device and by the transfer device.

If an image secondarily transferred to a recording medium is a color image formed of multiple color toners, it is possible to have a configuration in which each color toner image is sequentially overlapped on the intermediate transfer body by the transfer device to form an image thereon, which is secondarily transferred once to a recording medium by an intermediate transfer device.

The intermediate transfer body is not particularly limited and can be suitably selected from the known transfer members including an intermediate transfer belt.

The intermediate transfer body may also include an elastic intermediate transfer belt. The elastic intermediate transfer belt can have a structure in which a flexible elastic layer is laminated on a relatively rigid base layer with sufficient bendability.

Additionally, to prevent the intermediate transfer body from meandering, a guide member may be provided on its inner peripheral surface.

The transfer device (the primary transfer device, the secondary transfer device) preferably has a transfer unit for peeling-charging the visible image formed on the image bearer to the side of the recording medium.

Specific examples of the transfer unit include, but are not limited to, a corona transfer unit using corona discharging, a transfer belt, a transfer belt, a transfer roller, a pressure transfer roller and an adhesive transfer unit.

A typical example of the recording medium is plain paper but any paper to which a non-fixed image after development is transferred can be suitably used. PET base for an overhead projector can be also used.

### Fixing Device and Fixing

The fixing device has no particular limit provided that it can fix a transfer image transferred onto a recording medium and can be suitably selected to suit to a particular application. Known heating and pressure devices are preferable.

A combination of a heating roller and a pressure roller and a combination of a heating roller, a pressure roller, and an endless belt can be used as the heating and pressure device.

The fixing process has no particular limit provided that it includes a process of fixing a visible image transferred onto a recording medium and can be suitably selected to suit to a particular application. For example, fixing can be conducted each time an image is transferred for each color toner, or subsequent to transferring a stacked image of all color toners at once. The fixing process can be conducted by the fixing device.

The heating temperature at the heating and pressing device is preferably from 80 to 200 degrees Celsius.

In the present disclosure, for example, any known optical fixing device can be used in combination with or in place of the fixing device depending on a particular application.

There is no specific limitation to the surface pressure in the fixing process and it can be suitably selected to suit to a particular application. Preferably, the surface pressure is from 10 to 80 N/cm².

### Cleaning Device and Cleaning Process

There is no specific limitation to the selection of the cleaning device (cleaner) and any known cleaner that can remove the toner remaining on the image bearer is suitably used.

Specific examples of such cleaners include, but are not limited to, a magnetic brush cleaner, an electrostatic brush cleaner, a magnetic roller cleaner, a blade cleaner, a brush cleaner, and a web cleaner.

Any cleaning process that can remove the toner remaining on the image bearer is suitably used. For example, the cleaning process can be conducted by the cleaning device mentioned above.

### Quenching Device and Quenching Process

The quenching (discharging) device has no particular limit as long as it can apply a discharging bias to a photoconductor for discharging and can be suitably selected to suit to a particular application. For example, a discharging lamp is suitable.

The discharging process has no specific limit as long as it includes applying a discharging bias to a photoconductor for discharging and can be suitably selected to suit to a particular application. For example, the charging process can be conducted by the charging device.

### Recycling Device and Recycling Process

The recycling device has no particular limit as long as it recycles toner removed by the cleaning device to the development device and can be suitably selected to suit to a particular application. For example, known conveying devices are suitable.

The recycling process has no particular limit as long as it includes recycling toner removed in the cleaning process to the developing device and can be suitably selected to suit to a particular application. For example, the recycling process can be conducted by the recycling device.

Hereinafter, the image forming apparatus relating to the present disclosure is described with reference to the accompanying drawing. It is to be noted that the following embodiments are not limiting the present disclosure and any deletion, addition, modification, change, etc. can be made within a scope in which man in the art can conceive including other embodiments, and any of which is included within the scope of the present disclosure as long as the effect and feature of the present disclosure are demonstrated.

Next, an embodiment of image forming with the image forming apparatus of the present disclosure is described with reference to FIGURE. One of the image forming apparatuses in the present embodiment is a printer. However, the image forming apparatus is not particularly limited to an apparatus such as a printer, a photocopier, a facsimile machine, or a multifunction peripheral as long as it can form images with toner.

FIGURE is a schematic diagram illustrating an example of the image forming apparatus for use in the present disclosure.

An image forming apparatus 200 includes a sheet feeding unit 210, a conveyance unit 220, an image forming part (latent electrostatic image forming device) 230, a transfer unit (transfer device) 240, and a fixing unit (fixing device) 250.

The sheet feeding unit 210 includes a sheet feeding cassette 211 on which sheets to be fed are piled and a feeding roller 212 that feeds a sheet (recording medium) P piled on the sheet feeding cassette 211 one by one.

The conveyance unit 220 includes a roller 221 for conveying the sheet P fed by the feeding roller 212 toward the transfer unit 240, a pair of timing rollers 222 for pinching the front end of the sheet P conveyed by the roller 221 on standby and sending out the sheet P to the transfer unit 240 at a particular timing, and ejection rollers 223 for ejecting the sheet P on which a color toner image is fixed by the fixing unit 250 to an ejection tray 224.

The image forming device 230 includes an image forming unit (latent electrostatic image bearer) 180Y that forms an image using a developing agent containing yellow toner, an image forming unit 180C that forms an image using a developing agent containing cyan toner, an image forming unit 180M that forms an image using a developing agent containing magenta toner, and an image forming unit 180K that forms an image using a developing agent containing black toner, sequentially standing from left to right in the drawing with a particular interval, and an irradiator 233.

The image forming unit 180 (180Y, 180C, 180M, 180K) is provided to be rotatable clockwise in the drawing and includes a drum photoconductor 231 (231Y, 231C, 231M, 231K) where latent electrostatic images and toner images are formed, a charger 232 (232Y, 232C, 232M, 232K) for uniformly charging the surface of the drum photoconductor 231 (231Y, 231C, 231M, 231K), and a cleaner 236 (236Y, 236C, 236M, 236K) for removing residual toner from the surface of the drum photoconductor 231 (231Y, 231C, 231M, 231K).

The image forming unit 180 (180Y, 180C, 180M, 180K) includes toner bottles 234 (234Y, 234C, 234M, 234K) for containing toner for each color, and sub-hoppers 160 (160Y, 160C, 160M, 160K) for replenishing toner supplied from the toner bottles 234 (234Y, 234C, 234M, 234K).

Any of the image forming units 180 (180Y, 180C, 180M, 180K) can be referred to as an image forming unit when it indicates an arbitrary unit.

The irradiator 233 irradiates the drum photoconductor 231 (231Y, 231C, 231M, and 231K) with a laser beam L emitted from a light source 233a in response to image data, and the laser beam L is reflected by a polygon mirror (233bY, 233bC, 233bM, and 233bK) rotatably driven by a motor.

In addition, the developing agent contains toner and carrier. The four image forming units 180 (180Y, 180C, 180M, 180K) have substantially the same structure except for the individual developing agents used for respective image forming units.

The transfer unit 240 includes a driving roller 241, a driven roller 242, an intermediate transfer belt 243 disposed rotatable counterclockwise in the drawing in accordance with the drive of the driving roller 241, a primary transfer roller 244 (244Y, 244C, 244M, and 244K) disposed facing the drum photoconductor 231 (231Y, 231C, 231M, and 231K) with the intermediate transfer belt 243 therebetween, and a secondary facing roller 245 and a secondary transfer roller 246 disposed facing each other at the point of the toner image transferred to the sheet P with the intermediate transfer belt 243 therebetween.

The fixing device 250 with a heater inside includes a fixing belt 251 for heating the sheet P and a pressing roller 252 for forming a nip with the fixing belt 251 by rotatably pressing it. Heat is applied with pressure to the color toner image on the sheet P at the nipping portion, thereby fixing the color toner image.

The sheet P on which the color toner image is fixed is ejected to the ejection tray 224 by the ejection rollers 223, which completes a series of image forming process.

The terms of image forming, recording, and printing in the present disclosure represent the same meaning.

Also, recording media, media, and print substrates in the present disclosure have the same meaning unless otherwise specified.

Having generally described preferred embodiments of this disclosure, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

The present disclosure is described next in detail with reference to Examples and Comparative Examples but is not limited to these Examples. “Parts” represents parts by mass and “percent” represents percent by mass unless otherwise specified in the following description.

The measuring methods are as follows:

### Method of Measuring Melting Point and Glass Transition Temperature Tg

The glass transition temperature Tg of the resin was measured with a differential scanning calorimetry (DSC) system, Q-200, available from TA Instruments. A total of 5.0 mg of the resin sample was put into an aluminum sample pan, which was then held on a holder unit and placed in an electric furnace. A reference sample of alumina (aluminum oxide, available from FUJIFILM Wako Pure Chemical Corporation) weighing 10 mg was used, and like the sample, it was placed in an aluminum sample pan. Under a nitrogen atmosphere, the sample was heated from 0 to 150 degrees Celsius at a heating rate of 10 degrees Celsius/min (first heating), then cooled from 150 to 0 degrees Celsius at a cooling rate of 10 degrees Celsius/min (cooling process), and heated again from 0 to 150 degrees Celsius at a heating rate of 10 degrees Celsius/min (second heating). The heat flux changes during these processes were measured, and a graph of temperature versus heat flux was plotted to obtain a DSC curve. The DSC curve obtained was analyzed using the analysis program in the Q-200 system. The DSC curve for the second heating was selected, and the glass transition temperature of the resin sample was determined from the intersection of the baseline extension line of the DSC curve at temperatures lower than the enthalpy relaxation and the tangent indicating the maximum slope during enthalpy relaxation. Similarly, the DSC curve for the second heating was selected, and the peak temperature of heat absorption was considered as the melting point of the crystalline resin or wax sample.

### Measuring of Weight Average Molecular Weight Mw

The measuring average molecular weight Mw was measured using a gel permeating chromatography (GPC) device (e.g., HLC-8220GPC by Tosoh Corporation). The column used was TSK gel Super HZM-M 15 cm triplet (available from TOSOH CORPORATION). The resin to be measured was dissolved in tetrahydrofuran (THF) (containing stabilizers, available from Fujifilm Wako Pure Chemical Corporation) to prepare a 0.15 percent solution. After filtration through a 0.2 μm filter, the filtrate was used as the sample. A total of 100 μl of the THF sample solution was injected into the measuring device, and measurements are conducted at a flow rate of 0.35 ml/min at a temperature of 40 degrees Celsius. The molecular weight was calculated by using a standard curve made by a mono-dispersed polystyrene standard sample. The polystyrene standard samples used were the THF solutions (solutions A to C) of the following three types of monodisperse polystyrene standard samples from the Showdex STANDARD series, available from Showa Denko Co., Ltd. Measurements were conducted under the aforementioned conditions to create a calibration curve using the retention time of the peak top as the light-scattering molecular weight of the monodisperse polystyrene standard samples. The detector used was a refractive index (RI) detector.
Solution A: S-7300 2.5 mg, S-602 2.5 mg, S-46 2.5 mg, S-2.8 2.5 mg, THF 50 mL
Solution B: S-3500 2.5 mg, S-277 2.5 mg, S-18 2.5 mg, S-1.3 2.5 mg, THF 50 mL
Solution C: S-1700 2.5 mg, S-136 2.5 mg, S-6.7 2.5 mg, toluene 2.5 mg, THF 50 mL

### Acid Value AV, Hydroxyl Value OHV Measurement

The acid value AV and hydroxyl value OHV of the resin were measured according to JIS K0070 (Test methods for acid value, saponification value, ester value, iodine value, hydroxyl value and unsaponifiable matter of chemical products). The measuring solvent of acid value used was a mixed solvent of acetone (available from Fujifilm Wako Pure Chemical Corporation), methanol (available from Fujifilm Wako Pure Chemical Corporation), and toluene (available from Fujifilm Wako Pure Chemical Corporation) at a ratio of acetone:methanol:toluene=12.5:12.5:75.

The measuring solvent of hydroxyl value used was tetrahydrofuran (THF) (available from Fujifilm Wako Pure Chemical Corporation).

### Measuring Volume Average Particle Diameter Dv

The volume average particle diameter Dv of resin particles and toner was measured using a Coulter Multisizer III (aperture diameter 100 μm, available from Beckman Coulter) and analysis software, Beckman Coulter Multisizer 3 (version 3.51, available from Beckman Coulter). A measuring sample of 10 mg was added to 5 mL of a 10 percent surfactant solution (alkylbenzenesulfonic acid salt, NeoGen SC-A, available from DKS Co., Ltd.) and dispersed for 1 minute using an ultrasonic disperser. Then 25 mL of electrolyte solution, Isoton III (available from Beckman Coulter), was added as desired, and dispersed for 1 minute to prepare a sample dispersion solution using an ultrasonic disperser. Subsequently, an appropriate amount of the electrolyte solution and the sample dispersion solution of 100 mL were added to a beaker, and 30,000 particles were measured at a concentration where the particle diameter of 30,000 particles was able to be measured in 20 seconds. The volume average particle diameter Dv was then determined from its particle size distribution.

### Average Circularity and Content of Microfines of at Most 2 μm

The average circularity and the amount of microfines (at most 2 μm) of the resin particles and toner were measured using a Flow Particle Imaging Analyzer FPIA-3000 (available from Sysmex Corporation). One percent NaCl aqueous solution was prepared using sodium chloride (first grade, available from Fujifilm Wako Pure Chemical Corporation), and then dispersant, alkylbenzenesulfonic acid salt (NeoGen, available from DKS Co., Ltd.), was added in the range of 0.1 to 5 mL to a liquid of 50 to 100 mL filtered through a 0.45 μm filter. Subsequently, 1 to 10 mg of the sample was added.

The mixture was dispersed for 1 minute using an ultrasonic disperser to adjust the particle concentration to 5,000 to 15,000 particles/μL.

This liquid dispersion with adjusted particle concentration was then measured.

### Manufacturing Examples 1 to 22 of Polyester Resin A

### Manufacturing of Polyester Resins A-1 to A-22

To a reaction vessel equipped with a cooling pipe, a stirrer, and a nitrogen introduction pipe, Raw Materials A shown in Tables 1-1 to 1-2 were added, at a molar ratio (OH/COOH) of hydroxyl groups to carboxylic acid groups adjusted to 1.2.

Additionally, a condensation catalyst, tetra-n-butoxy titanate (titanium dihydroxy bis(triethanolaminate), available from Tokyo Chemical Industry Co. Ltd.), was added at 1,000 ppm to the entire of the monomer. The temperature was raised to 200 degrees Celsius over 2 hours under a nitrogen stream, then further raised to 230 degrees Celsius over 8 hours, during which water produced was removed, and the reaction was allowed to proceed for 5 hours. Subsequently, the reaction was carried out for 1 hour under a reduced pressure of 5 to 15 mmHg, then cooled to 200 degrees Celsius. Anhydrous trimellitic acid (available from Tokyo Chemical Industry Co. Ltd.) was added in an amount shown in Tables 1-1 and 1-2, and the reaction was carried out for 1 hour at 200 degrees Celsius under atmospheric pressure. The reaction was continued under reduced pressure of 5 to 20 mmHg until the desired molecular weight was reached, obtaining Polyester Resins A-1 to A-22 as Polyester Resins A.

Polyester Resins A-1 to A-22 obtained were subjected to measurements of glass transition temperature Tg, weight average molecular weight, acid value AV, hydroxyl value OHV, and the ratio (OHV/AV). The results are shown in Tables 1-1 to 1-2.

### Manufacturing Example 1 of Polyester Resin Emulsion

### Production of Polyester Resin Emulsion EM-1

A total of 150 parts by mass of Polyester resin A-1 and 150 parts by mass of methyl ethyl ketone (available from Fujifilm Wako Pure Chemical Corporation) were placed in a 500 mL separable flask equipped with a stirrer.

Additionally, sodium hydroxide (0.3N) (available from Fujifilm Wako Pure Chemical Corporation) was added at 80 percent equivalent to the acid value of Polyester Resin A-1 to neutralize it, preparing a resin liquid mixture. Subsequently, while the resin liquid mixture was stirred, deionized water was gradually added up to 400 parts to conduct phase inversion emulsification.

Then the resulting substance was subjected to solvent removal under reduced pressure using an evaporator. Deionized water was added to achieve a solid content concentration of 25 percent by mass, obtaining Polyester Resin Emulsion EM-1.

### Manufacturing Examples 2 to 22 of Polyester Resin Emulsion

Polyester Resin Emulsion EM-2 to EM-22 were obtained in the same manner as in Manufacturing Example 1 for Polyester Resins A-2 to A-22.

The Polyester Resin Emulsions EM-1 to EM-22 obtained were subjected to measurement of median diameter D50. The results are shown in Table 2.

### Manufacturing Examples of Amorphous Polyester Resin B

### Manufacturing of Amorphous Polyester Resin B

To a reaction vessel equipped with a cooling pipe, a stirrer, and a nitrogen introduction pipe, acid monomers and alcohol monomers shown in Table 1 were added, at a molar ratio (OH/COOH) of hydroxyl groups to carboxylic acids adjusted to 1.2.

Additionally, a condensation catalyst, tetra-n-butoxy titanium, was added at 1,000 ppm to the entire of the monomer.

The temperature was raised to 200 degrees Celsius over 2 hours under a nitrogen stream, then further raised to 230 degrees Celsius over 8 hours, followed by reaction for 5 hours during which water produced was removed. Subsequently, the reaction was carried out for 1 hour under a reduced pressure of 5 to 15 mmHg, then cooled to 200 degrees Celsius. Anhydrous trimellitic acid was added in the amounts shown in Table 4, and the reaction was carried out for 1 hour at 200 degrees Celsius under atmospheric pressure. Finally, the reaction was continued under reduced pressure of 5 to 20 mmHg until the desired molecular weight was reached, obtaining Amorphous Polyester Resin B as the amorphous polyester resin B.

Amorphous Polyester Resin B obtained was subjected to measurements of glass transition temperature Tg, weight average molecular weight, acid value AV, and hydroxyl value OHV. The results are shown in Table 1-2.

### Manufacturing Example of Crystalline Polyester Resin

### Manufacturing of Crystalline Polyester Resin C

To a reaction vessel equipped with a cooling pipe, a stirrer, and a nitrogen introduction pipe, 1,6-hexanediol (available from Tokyo Chemical Industry Co., Ltd.) and sebacic acid (available from Tokyo Chemical Industry Co., Ltd.) as the dicarboxylic acid component were introduced to achieve a molar ratio (OH/COOH) of hydroxyl groups to carboxylic acids of 1.1. Additionally, as a condensation catalyst, titanium dihydroxy bis(triethanolaminate) (available from Tokyo Chemical Industry Co., Ltd.) was added at 500 ppm relative to the entire of the monomer. The temperature was raised to 180 degrees Celsius over 2 hours under a nitrogen stream, and the generated water was removed while the reaction proceeded for 8 hours. Subsequently, the temperature was gradually raised to 220 degrees Celsius while removing the generated water under a nitrogen stream, and the reaction was allowed to proceed for 5 hours. Under a reduced pressure of 5 to 20 mmHg, Crystalline Polyester Resin C with a melting point of 68 degrees Celsius, an acid value of 10.5 mg KOH/g, and a weight average molecular weight of 11,000 was obtained.

### Manufacturing Example 1 of Liquid Dispersion of Crystalline Polyester Resin

### Manufacturing of Liquid Dispersion C-1 of Crystalline Polyester Resin

In a reaction vessel equipped with a cooling pipe, a thermometer, and a stirrer, 10 parts by mass of Crystalline Polyester Resin C and 90 parts by mass of ethyl acetate (available from FujiFilm Wako Pure Chemical Corporation) were placed and heated to 77 degrees Celsius until fully dissolved. The mixture was then cooled to 30 degrees Celsius over 1 hour with stirring. Subsequently, wet grinding was conducted using an Ultra Bead Mill (available from Aimex Corporation) under the following conditions: a liquid feed rate of 1.0 kg/hr, a disc peripheral speed of 10 m/second, 80 percent by volume of 0.5 mm zirconia beads, and 6 passes. Ethyl acetate was then added to adjust the solid content to 10 percent, resulting in Liquid Dispersion C-1 of Crystalline Polyester Resin with a median particle diameter D50 of 0.3 μm, as measured by a laser particle size distribution analyzer LA-920 (available from HORIBA, Ltd.).

### Manufacturing Example 2 of Liquid Dispersion of Crystalline Polyester Resin

### Manufacturing of Liquid Dispersion C-2 of Crystalline Polyester Resin

In a 500 ml separable flask equipped with a stirrer, 150 parts by mass of Crystalline Polyester Resin C, 75 parts by mass of methyl ethyl ketone (available from FujiFilm Wako Pure Chemical Corporation), and 75 parts by mass of isopropyl alcohol (available from FujiFilm Wako Pure Chemical Corporation) were placed and heated to 65 degrees Celsius to dissolve it. Subsequently, to the resulting liquid, ammonia solution (available from FujiFilm Wako Pure Chemical Corporation) equivalent to 60 percent of the acid value of Crystalline Polyester Resin C was added to prepare a liquid mixture of the resin. Next, the liquid mixture of the resin was stirred at 65 degrees Celsius while 400 parts of deioniezd water was gradually added to conduct phase inversion emulsification. Afterward, the obtained material was subjected to solvent removal under reduced pressure using an evaporator, and deionized water was added to adjust the solid content to 25 percent by mass. This process resulted in Liquid Dispersion C-2 of Crystalline Polyester Resin, which contained a crystalline polyester resin emulsion with a median diameter D50 of 0.3 μm.

### Manufacturing Example of Colorant Master Batch

### Manufacturing of Colorant Master Batch MB

A total of 100 parts of Amorphous Polyester Resin B, 100 percent by mass of cyan pigment (Pigment Blue 15:3), and 50 parts by mass of deionized water were thoroughly mixed, and the mixture was kneaded using an open roll type kneading machine (Kneadex, available from NIPPON COKE & ENGINEERING CO., LTD.). The kneading temperature was maintained at 80 degrees Celsius, then raised to 120 degrees Celsius to remove water, obtaining Colorant Master Batch (MB) with a resin-to-pigment ratio (mass ratio) at 1:1.

### Manufacturing Example of Liquid Dispersion of Colorant

A total of 30 parts by mass of cyan pigment (Pigment Blue 15:3), 3 parts by mass of anionic surfactant (sodium linear alkylbenzenesulfonate (Neogen, available from Daiichi Kogyo Seiyaku Co., Ltd.), and 67 parts by mass of deionized water were placed in a container. The mixture was then dispersed for 30 minutes at 6,000 rpm using a TK homomixer (available from Tokushu Kikai Co., Ltd.), followed by dispersion process using a high-pressure disperser, Ultimiser (Starburst, available from Sugino Machine Limited), at a pressure of 245 MPa for 20 passes. Subsequently, deionized water was added to adjust the solid content concentration to 25 percent by mass, obtaining Liquid Dispersion of Colorant.

### Manufacturing Example 1 of Liquid Dispersion of Wax

### Manufacturing of Liquid Dispersion W-1 of Wax

In a reaction vessel equipped with a cooling pipe, a thermometer, and a stirrer, 20 parts by mass of ester wax (WE-11, melting point of 70 degrees Celsius, available from NOF CORPORATION) and 80 parts by mass of ethyl acetate (available from FujiFilm Wako Pure Chemical Corporation) were placed and heated to 77 degrees Celsius until fully dissolved. The mixture was then cooled to 30 degrees Celsius over 1 hour with stirring. Subsequently, wet grinding was conducted using an Ultra Bead Mill (available from Aimex Corporation) under the following conditions: a liquid feed rate of 1.0 kg/hr, a disc peripheral speed of 10 m/second, 80 percent by volume of 0.5 mm zirconia beads, and 6 passes. Ethyl acetate was then added to adjust the solid content to 20 percent, resulting in Liquid Dispersion W-1 of Wax with a median particle diameter (D50) of 0.6 μm, as measured by a laser particle size distribution analyzer LA-920 (available from HORIBA, Ltd.).

### Manufacturing Example 2 of Liquid Dispersion of Wax

### Manufacturing of Liquid Dispersion W-2 of Wax

A total of 30 parts by mass of ester wax with a melting point of 70 degrees Celsius (WE-11, available from NOF CORPORATION), 2 parts by mass of anionic surfactant (sodium linear alkylbenzenesulfonate (Neogen, available from DKS Co., Ltd.), and 68 parts by mass of deionized water were placed in a container. The mixture was dispersed in the container cooled with ice water for 2 hours at 8,000 rpm using a TK homomixer (available from Tokushu Kikai Co., Ltd.). Subsequently, deionized water was added to adjust the solid content concentration to 25 percent by mass, obtaining Liquid Dispersion W-2 of Wax with a median diameter D50 measured by a laser particle size distribution analyzer LA-920 (available from Horiba, Ltd.) of 0.6 μm.

### Manufacturing Example 1 of Liquid Dispersion of Core Particle

### Manufacturing of Liquid Dispersion CR-1 of Core Particle by Suspension Emulsion Method

In a container equipped with a stirrer and a thermometer, 68 parts by mass of deionized water, 1 part by mass of sodium carboxymethyl cellulose (available from DKS Co., Ltd.), 16 parts by mass of a 48 percent aqueous solution of sodium dodecyl diphenyl ether disulfonate (Eleminol MON-7, available from Sanyo Chemical Industries, Ltd.), and 5 parts by mass of ethyl acetate were mixed and stirred. Subsequently, 10 parts by mass of an emulsion for particle size control containing a copolymer of styrene-methacrylic acid-butyl acrylate-ethylene oxide adduct sulfonic ester sodium salt (solid content concentration: 20 percent, median diameter: 50 nm, available from Sanyo Chemical Industries, Ltd.) were added to prepare Aqueous Phase Liquid.

Next, in another container equipped with a stirrer and a thermometer, 76 parts by mass of Amorphous Polyester Resin B, 60 parts by mass of Liquid Dispersion C-1 of Crystalline Polyester Resin, 30 parts by mass of Liquid Dispersion W-1 of Wax, and 12 parts by mass of Colorant Master Batch MB were added. Ethyl acetate was then added to adjust the solid content concentration to 50 percent, and the mixture was stirred until completely dissolved. Using a TK homomixer (available from Tokushu Kikai Co., Ltd.), the mixture was then dispersed at a rotation speed of 8,000 rpm for 2 hours to achieve uniform dissolution and suspension, thereby preparing the Oil Phase.

A total of 50 parts by mass of Oil Phase was added to a container containing 75 parts by mass of Aqueous Phase Liquid to obtain emulsification slurry by mixing for 1 minute at a rotation speed of 12,000 rpm using a TK homomixer (available from Tokushu Kikai Co., Ltd.) at a liquid temperature of 30 to 40 degrees Celsius.

The obtained emulsified slurry was transferred to another container equipped with a stirrer, a nitrogen introduction tube, and a thermometer, and during stirring, it was heated to 50 degrees Celsius to remove ethyl acetate under a nitrogen atmosphere. A ten percent aqueous solution of sodium hydroxide (available from Fuji Film Wako Pure Chemical Corporation) was added to adjust the pH of the emulsified slurry to 12. Thereafter, it was heated at 45 degrees Celsius for 10 hours, dissolving and removing the emulsion for particle size control adhering to the particle surface in the emulsified slurry, followed by suction filtration to obtain solid content.

The solid content obtained was subjected to a washing process of reslurrying with deionized water equivalent to 40 times the mass of the solid content, followed by filtering after through stirring. This washing process was repeated once more, and deionized water was added again to adjust the solid content concentration to 25 percent by mass, thereby obtaining Liquid Dispersion CR-1 of Core Particle.

Liquid Dispersion CR-1 of Core Particle was subjected to measurements of volume average particle size and average circularity. The results are shown in Table 3.

### Manufacturing Example 2 of Liquid Dispersion of Core Particle

### Production of Liquid Dispersion CR-2 of Core Particle by Emulsion Aggregation Method

To a container equipped with a stirrer, 150 parts by mass of Amorphous Polyester Resin B and 150 parts of methyl ethyl ketone were added. Furthermore, sodium hydroxide (0.3N) was added at a neutralization rate of 70 percent equivalent to the acid value of Amorphous Polyester Resin B to prepare a resin liquid mixture. Next, while the resin liquid mixture was stirred, 400 parts of deionized water was gradually added to conduct phase inversion emulsification. Subsequently, solvent removal was carried out under reduced pressure using an evaporator, and deionized water was added to adjust the solid content concentration to 25 percent. This process yielded Amorphous Polyester Resin B Emulsion with a median diameter D50 measured by laser-type particle size distribution measurement device LA-920 (available from Horiba, Ltd.) of 0.2 μm.

Then 328 parts by mass of Amorphous Polyester Resin B Emulsion, 24 parts by mass of Liquid Dispersion C-2 of Crystalline Polyester Resin, 24 parts by mass of Liquid Dispersion W-2 of Wax, and 24 parts by mass of Colorant Liquid Dispersion were placed in another container equipped with a stirrer and a thermometer. While the mixture was stirred, a 20 percent aqueous solution of magnesium sulfate (available from Fuji Film Wako Pure Chemical Corporation) at 20 parts by mass per 2 parts by mass per minute was added dropwise, followed by heating to 55 degrees Celsius. After the emulsion volume average particle size Dv reached 5 μm, a 10 percent aqueous solution of sodium chloride (available from Fuji Film Wako Pure Chemical Corporation) at 120 parts by mass was added. The mixture was then heated to 60 degrees Celsius and stirred for 1 hour, followed by cooling to room temperature. Deionized water was then added to adjust the solid content concentration to 25 percent, obtaining Liquid Dispersion CR-2 of Core Particle.

Liquid Dispersion CR-2 of Core Particle was subjected to measurements of volume average particle size and average circularity. The results are shown in Table 3.

### Manufacturing Example 3 of Liquid Dispersion of Core Particle

### Manufacturing of Liquid Dispersion CR-3 of Core Particle by Suspension Emulsion Method

A total of 76 parts by mass of Amorphous Polyester Resin B, 6 parts by mass of Crystalline Polyester Resin C, 6 parts by mass of ester wax (WE-11, available from NOF CORPORATION) with a melting point of 70 degrees Celsius, and 12 parts by mass of Colorant Master Batch MB were preliminarily mixed using a Henschel mixer (FM10B, available from Mitsui Miike Chemical Engineering Machinery), then melted and kneaded at 85 degrees Celsius using a twin-screw kneader (PCM-30, available from Ikegai Corporation). The melt-kneaded material obtained was cooled to room temperature and coarse-ground to 200 to 300 μm using a hammer mill. Next, using a counter jet mill (200AFG, available from Hosokawa Micron Corporation), the material was finely ground under the powder air pressure adjusted to achieve a weight average particle diameter of 5.6±0.3 μm. Subsequently, classification was performed using an air classifier (MDS-I, available from Nippon Pneumatic Mfg. Co., Ltd.) to achieve a weight average particle diameter of 6.0±0.2 μm and a proportion of fine particles at or below 4 μm of 10 or less percent by number, under the louver opening adjusted as necessary, to obtain Classified Particles. Then 25 parts by mass of Classified Particles, 73 parts by mass of deionized water, and 2 parts by mass of anionic surfactant (linear sodium alkylbenzenesulfonate, Neogen, available from DKS Co., Ltd.) were placed in another container equipped with a stirrer. Through sufficient stirring, Liquid Dispersion of Core Particle CR-3 adjusted to a solid content concentration of 25 percent was obtained.

Liquid Dispersion CR-3 of Core Particle was subjected to measurements of volume average particle size and average circularity. The results are shown in Table 3.

### Manufacturing Example of Carrier

A total of 5,000 parts by mass of Mn ferrite particles with a weight average particle diameter of 35 μm was used as the core material.

For the coating material, a coating solution was prepared by dispersing the following ingredients for 10 minutes using a stirrer: 300 parts by mass of toluene (available from by Fuji Film Wako Pure Chemical Corporation), 300 parts by mass of butyl cellosolve (available from Fuji Film Wako Pure Chemical Corporation), 60 parts by mass of an acrylic resin solution (containing methyl methacrylate:methacrylicacid:2-hydroxyethyl acrylate=5:9:3, solid content 50 percent in toluene solution, Tg 38 degrees Celsius), 15 parts by mass of N-tetramethoxymethylbenzoguanamine resin solution (degree of polymerization 1.5, solid content 77 percent by mass in toluene solution), and 15 parts by mass of alumina particles (average primary particle diameter 0.30 μm).

The coating solution prepared was then applied onto the core material using a coating device that applied coating while forming a swirling flow with a rotating bottom plate disk and stirring blades in a fluidized bed. The resulting coated material was baked in an electric furnace at 220 degrees Celsius for 2 hours to obtain Carrier.

### Example 1

### Manufacturing of Resin Particles T or Toner

In a container equipped with a stirrer and thermometer, 320 parts of Liquid Dispersion CR-1 of Core Particles (solid content concentration: 25 percent) and 80 parts of Polyester Resin Emulsion EM-1 (solid content concentration: 25 percent) were added. While stirring, a 20 percent aqueous solution of magnesium sulfate was slowly added dropwise at a rate of 1 part per minute, and the addition was continued until the core particles in the system ceased Brownian motion, as observed under an optical microscope. Subsequently, the temperature was raised to 55 degrees Celsius, and stirring was continued for 30 minutes. Thereafter, 100 parts of a 10 percent aqueous solution of sodium chloride were added, and the temperature was raised to 70 degrees Celsius. Stirring at 70 degrees Celsius was continued until the average circularity reached 0.970. Subsequently, the container was moved to an ice bath for cooling to room temperature, followed by suction filtration to obtain solid contents.

To the obtained solids, 800 parts by mass of deionized water were added, stirred to re-slurry, and then subjected to suction filtration to obtain solids. This process was repeated five times, followed by drying at 45 degrees Celsius for 48 hours in a fluidized bed dryer. The resulting dried matter was sieved with a 75 μm mesh to obtain Resin Particles T, referred to as Resin Particles T-1.

A total of 1.0 part by mass of hydrophobic silica (HDK-2000, available from Wacker Chemie AG) and 0.3 parts by mass of titanium oxide (MT-150AI, available from TAYCA CORPORATION) were added to 100 parts by mass of Resin Particles T-1 obtained, and mixed using a Henschel mixer. The mixture was then sieved with a 25 μm mesh to obtain Toner TN-1. The toner obtained was measured about volume average particle diameter Dv and average circularity. The results are shown in Table 4.

### Evaluation on Homogeneity of Shell

Resin Particles T-1 were embedded in procured epoxy resin (S-31, available from DEVCON) and hardened. Subsequently, ultra-thin sections were prepared using a diamond knife with an ultramicrotome (Leica EM UC7, available from Leica). Its thickness of the sections was adjusted to around 100 nm, utilizing the interference color of the epoxy resin. Furthermore, the sections were placed on copper grid meshes and subjected to vapor staining using a 5 percent aqueous solution of ruthenium tetroxide (available from FujiFilm Wako Pure Chemical Corporation). Images of the resin particle cross-sections were recorded utilizing a transmission electron microscope (JEM-2100F, available from JEOL Ltd.). The formation state of the shell was determined based on whether crystalline polyester resin, wax, and colorant were exposed on the surface of the resin particles based on the fact that those components are not exposed on the surface of the cross section of a toner particle with a shell.

Specifically, the cross-sections of 30 randomly selected resin particles were observed to determine the proportion (P) of particles with no exposure of crystalline polyester resin, wax, and colorant on the surface. The proportion P indicates the degree of homogeneity in the aggregation state of the shell particles. The evaluation was conducted based on the following criteria, and the results are shown in Tables 4.

### Evaluation Criteria

S: Proportion P is 90 percent or higher
A: Proportion P is 80 to less than 90 percent
B: Proportion P is 60 to less than 80 percent
C: Proportion P is less than 60 percent

### Manufacturing of Developing Agent

Developing Agent D-1, which was a two-component developing agent, was obtained by uniformly mixing 7 parts by mass of Toner TN-1 with 100 parts by mass of Carrier using a type of tumbler mixer (available from Willy A. Bachofen (WAB) GmbH) that rotated the container at 48 rpm for 5 minutes.

### Evaluation on Mechanical Durability of Toner

Developing Agent D-1 was loaded into the developing unit of the digital color multifunction printer RICOH IM C5500 (available from Ricoh Co., Ltd.), and after printing 30,000 sheets in monochrome mode, the developing agent was extracted. An appropriate amount of the developing agent extracted was then placed in a gauge with a mesh opening of 32 μm, followed by air blowing to separate the toner from the carrier. Subsequently, the carrier (10 g) obtained was placed in a 50 ml glass bottle, and 10 ml of methyl ethyl ketone was added. The mixture was hand-shaken 50 times and left to rest for 10 minutes. Afterward, the supernatant methyl ethyl ketone solution was loaded in a glass cell, and the transmittance of the methyl ethyl ketone solution was measured using a turbidity meter. The evaluation was conducted based on the following criteria, and the results are shown in Tables 4.

### Evaluation Criteria

S: Transmittance of 95 percent or higher
A: Transmittance of 90 to less than 95 percent
B: Transmittance of 80 to less than 90 percent
C: Transmittance of less than 80 percent

### Evaluation on Charge Stability of Toner

The developing unit of the digital color multifunction peripheral RICOH IM C5500 (available from Ricoh Co., Ltd.) was loaded with Developing Agent D-1. In monochrome mode, an image chart with a 5 percent image area ratio was output in A4 landscape orientation on A4 My Recycle Paper 100 (available from NBS Ricoh Co., Ltd.) in cycles of 5 sheets per job. The carrier charge size was measured every 100,000 sheets, with a run length of 700,000 sheets.

The carrier charge size was measured as follows: the sampled two-component developing agent was placed in a blow-off gauge with a mesh size of 650, air-blown for 3 minutes at an air pressure of 5 kPa, and afterward, the charge size was measured using a Q/M Meter (available from Epping Co., Ltd.). The Q/M Meter was set with the following parameters: mesh size of 650 mesh (stainless steel); soft blow pressure (1050 V); and a suction time of 90 seconds. The charge size was calculated using the following Relationship 1.

Charge size (μC/g)=Total charge after 90 seconds (μC)/Amount of toner suctioned (g). Relationship 1

For the charge size obtained by this measurement, the difference between the initial carrier charge size at the start of the run and the maximum and minimum carrier charge sizes over time were evaluated as the charge fluctuation range. A smaller charge fluctuation range indicates better charge stability.

### Initial Fogging Evaluation

The developing unit of the digital color multifunction peripheral RICOH IM C5500 (available from Ricoh Co., Ltd.) was loaded with Developing Agent D-1. Under environmental conditions of 10 degrees Celsius and 15 percent RH, an image chart with a 5 percent image area ratio was continuously output in monochrome mode in A4 landscape orientation for 100 sheets on A4 My Recycle Paper 100 (available from NBS Ricoh Co., Ltd.). Afterward, fine-line images with a resolution of 600 dpi were output on Type 6000 Paper (available from NBS Ricoh Co., Ltd.), and the image density in the non-image area was measured using an X-Rite 938 densitometer (available from X-Rite Co., Ltd.). The evaluation criteria are as follows:

### Evaluation Criteria

S: Image density of less than 0.003
A: Image density of 0.003 to less than 0.010
B: Image density of 0.010 to less than 0.015
C: Image density of 0.015 to less than 0.030
D: Image density of 0.030 or higher

### Over Time Fogging Evaluation

After the charge stability evaluation was completed with 700,000 sheets run, a fine-line image in landscape orientation in monochrome mode at 600 dpi was output onto A4 Type 6000 paper (available from NBS Ricoh Co., Ltd.) under an environment of 10 degrees Celsius (15 percent RH). The image density of the non-image areas was measured using a spectrophotometer, X-Rite 938 (available from X-Rite Inc.). The evaluation criteria are as follows:

### Evaluation Criteria

S: Image density of less than 0.003
A: Image density of 0.003 to less than 0.010
B: Image density of 0.010 to less than 0.015
C: Image density of 0.015 to less than 0.030
D: Image density of 0.030 or higher

### Examples 2 to 16 and Comparative Examples 1 to 8

Resin Particles T-2 to T-24, Toners TN-2 to TN-24, and Developing Agents D-2 to D-24 were obtained in the same manner as in Example 1 except that the combinations of Liquid Dispersions CR-1 to CR-3 of Core Particle and Polyester Resin Emulsions EM-1 to EM-22 were changed as shown in Tables 6 to 10. Each was evaluated in the same manner as in Example 1. The results are shown in Table 4.

TABLE 1-1

| * the unit in Table is represented | | | Polyester Resin A | | | | | |
|---|---|---|---|---|---|---|---|---|
| in parts by mass otherwise specified. | | | A-1 | A-2 | A-3 | A-4 | A-5 | A-6 |
| Raw | Acid | Adipic acid | | | | | | |
| material A | | Isophthalic | 18.3 | 18.3 | 18.3 | 18.3 | 18.3 | 24.9 |
| | | acid | | | | | | |
| | | Terephthalic | | | | | | |
| | | acid | | | | | | |
| | | Succinic acid | 7.1 | 7.1 | 7.1 | 7.1 | 7.1 | 7.1 |
| | Alcohol | Adduct of | 21.6 | 22.0 | 21.5 | 22.1 | 21.8 | 21.9 |
| | | bisphenol A | | | | | | |
| | | with 2 mols of | | | | | | |
| | | ethylene oxide | | | | | | |
| | | Adduct of | | | | | | 13.6 |
| | | bisphenol A | | | | | | |
| | | with 2 mols of | | | | | | |
| | | propylene | | | | | | |
| | | oxide | | | | | | |
| | | 1,2-propane | 14.9 | 15.1 | 14.8 | 15.2 | 15.0 | 15.0 |
| | | diol | | | | | | |
| | | 1,3-Propane | | | | | | |
| | | diol | | | | | | |
| | | 1,4-butane diol | | | | | | |
| | | 2,3-Butane diol | | | | | | |
| | | Trimethylol | 1.6 | 0.4 | 2.1 | 0.1 | 1.0 | 0.8 |
| | | propane | | | | | | |
| | | 1,2,4-Butane | | | | | | |
| | | triol | | | | | | |
| | | Erythritol | | | | | | |
| | | Pentaerythritol | | | | | | |
| | | 1,2,7-Heptane | | | | | | |
| | | triol | | | | | | |
| | | Glycerol | | | | | | |
| | | Sorbitol | | | | | | |
| | Polyethylene | | 63.1 | 63.3 | 63.0 | 63.4 | 63.2 | 55.6 |
| | terephthalate (PET) | | | | | | | |
| Anhydrous trimellitic acid | | | 4.8 | 4.8 | 4.8 | 2.4 | 7.7 | 4.8 |
| * Molar ratio (mol percent) of | | | 32.7 | 33.2 | 32.5 | 33.3 | 32.9 | 33.0 |
| monomer in alcohol component | | | | | | | | |
| Resin properties | | Tg (g) | 60.5 | 60.3 | 60.9 | 60.5 | 60.8 | 57.3 |
| | | Mw (—) | 16,000 | 17,000 | 16,000 | 16,000 | 14,000 | 15,000 |
| | | AV | 21.3 | 19.4 | 18.9 | 10.1 | 25.0 | 19.1 |
| | | (mgKOH/g) | | | | | | |
| | | OHV | 14.9 | 5.8 | 18.9 | 5.3 | 8.8 | 8.4 |
| | | (mgKOH/g) | | | | | | |
| | | OHV/AV (—) | 0.70 | 0.30 | 1.00 | 0.52 | 0.35 | 0.44 |
| * the unit in Table is represented | | | Polyester Resin A | | | | | |
| in parts by mass otherwise specified. | | | A-7 | A-8 | A-9 | A-10 | A-11 | A-12 |
| Raw | Acid | Adipic acid | | | | | | |
| material A | | Isophthalic | 6.6 | 18.3 | 18.3 | 18.3 | 18.3 | 18.3 |
| | | acid | | | | | | |
| | | Terephthalic | | | | | | |
| | | acid | | | | | | |
| | | Succinic acid | 7.1 | 7.1 | 7.1 | 7.1 | 7.1 | 7.1 |
| | Alcohol | Adduct of | 4.7 | 21.9 | 21.8 | 21.8 | 21.9 | 21.9 |
| | | bisphenol A | | | | | | |
| | | with 2 mols of | | | | | | |
| | | ethylene oxide | | | | | | |
| | | Adduct of | | | | | | |
| | | bisphenol A | | | | | | |
| | | with 2 mols of | | | | | | |
| | | propylene | | | | | | |
| | | oxide | | | | | | |
| | | 1,2-propane | 6.8 | 15.1 | 15.0 | 15.0 | 7.5 | 7.5 |
| | | diol | | | | | | |
| | | 1,3-Propane | | | | | 7.5 | |
| | | diol | | | | | | |
| | | 1,4-butane diol | | | | | | 8.9 |
| | | 2,3-Butane diol | 8.5 | | | | | |
| | | Trimethylol | 0.7 | | | | 0.7 | 0.7 |
| | | propane | | | | | | |
| | | 1,2,4-Butane | | 0.5 | | | | |
| | | triol | | | | | | |
| | | Erythritol | | | 1.0 | | | |
| | | Pentaerythritol | | | | 1.0 | | |
| | | 1,2,7-Heptane | | | | | | |
| | | triol | | | | | | |
| | | Glycerol | | | | | | |
| | | Sorbitol | | | | | | |

| | | | | | | |
|---|---|---|---|---|---|---|
| Polyethylene | 76.7 | 63.3 | 63.2 | 63.2 | 63.3 | 63.3 |
| terephthalate (PET) | | | | | | |

| Anhydrous trimellitic acid | | 4.8 | 4.8 | 4.8 | 4.8 | 4.8 | 4.8 |
|---|---|---|---|---|---|---|---|
| * Molar ratio (mol percent) of | | 30.6 | 33.1 | 32.9 | 32.9 | 33.0 | 33.0 |
| monomer in alcohol component | | | | | | | |
| Resin properties | Tg (g) | 65.2 | 59.3 | 59.5 | 60.2 | 56.6 | 55.3 |
| | Mw (—) | 13,000 | 17,000 | 16,000 | 17,000 | 16,000 | 17,000 |
| | AV | 18.0 | 21.0 | 21.7 | 21.7 | 20.5 | 20.8 |
| | (mgKOH/g) | | | | | | |
| | OHV | 7.6 | 7.4 | 14.1 | 13.0 | 8.2 | 8.3 |
| | (mgKOH/g) | | | | | | |
| | OHV/AV (—) | 0.42 | 0.35 | 0.65 | 0.60 | 0.40 | 0.40 |

TABLE 1-2

| * the unit in Table is represented in | | | Polyester Resin A | | | | |
|---|---|---|---|---|---|---|---|
| parts by mass otherwise specified. | | | A-13 | A-14 | A-15 | A-16 | A-17 |
| Raw | Acid | Adipic acid | | | | | |
| material A | | Isophthalic | 18.3 | | 18.3 | 18.3 | 18.3 |
| | | acid | | | | | |
| | | Terephthalic | | 16.6 | | | |
| | | acid | | | | | |
| | | Succinic acid | 7.1 | 5.9 | 7.1 | 7.1 | 7.1 |
| | Alcohol | Adduct of | 21.9 | 62.0 | 22.0 | 21.2 | 21.8 |
| | | bisphenol A | | | | | |
| | | with 2 mols of | | | | | |
| | | ethylene oxide | | | | | |
| | | Adduct of | | 16.9 | | | |
| | | bisphenol A | | | | | |
| | | with 2 mols of | | | | | |
| | | propylene | | | | | |
| | | oxide | | | | | |
| | | 1,2-propane | | | 15.1 | 14.5 | 15.0 |
| | | diol | | | | | |
| | | 1,3- | | | | | |
| | | Propanediol | | | | | |
| | | 1,4-butanediol | | | | | |
| | | 2,3-Butane | 17.8 | | | | |
| | | diol | | | | | |
| | | Trimethylol | 0.8 | 1.3 | 0.3 | 3.0 | |
| | | propane | | | | | |
| | | 1,2,4-Butane | | | | | |
| | | triol | | | | | |
| | | Erythritol | | | | | |
| | | Pentaerythritol | | | | | |
| | | 1,2,7-Heptane | | | | | 1.0 |
| | | triol | | | | | |
| | | Glycerol | | | | | |
| | | Sorbitol | | | | | |

| | | | | | |
|---|---|---|---|---|---|
| Polyethylene | 63.3 | 67.0 | 14.5 | 62.8 | 14.3 |
| terephthalate (PET) | | | | | |

| Anhydrous trimellitic acid | | 4.8 | 4.8 | 4.8 | 4.8 | 4.8 |
|---|---|---|---|---|---|---|
| * Molar ratio (mol percent) | | 33.0 | 0.0 | 33.2 | 32.2 | 33.0 |
| of monomer in alcohol component | | | | | | |
| Resin properties | Tg (g) | 63.2 | 74.8 | 60.5 | 60.9 | 56.8 |
| | Mw (—) | 17,000 | 17,000 | 16,000 | 18,000 | 17,000 |
| | AV | 20.4 | 21.7 | 21.0 | 20.9 | 19.6 |
| | (mgKOH/g) | | | | | |
| | OHV | 8.6 | 13.0 | 5.3 | 26.1 | 9.8 |
| | (mgKOH/g) | | | | | |
| | OHV/AV (—) | 0.42 | 0.6 | 0.25 | 1.25 | 0.50 |

| | | | | | | | | Amorphous |
|---|---|---|---|---|---|---|---|---|
| | | | | | | | | polyester |
| * the unit in Table is represented | | | Polyester Resin A | | | | | resin B |
| in parts by mass otherwise specified. | | | A-18 | A-19 | A-20 | A-21 | A-22 | B-1 |
| Raw | Acid | Adipic acid | | | | | | 14.6 |
| material A | | Isophthalic | 18.3 | 18.3 | 18.3 | 18.3 | 18.3 | |
| | | acid | | | | | | |
| | | Terephthalic | | | | | 54.8 | 66.5 |
| | | acid | | | | | | |
| | | Succinic acid | 7.1 | 7.1 | 7.1 | 7.1 | 7.1 | |
| | Alcohol | Adduct of | 21.8 | 22.0 | 22.1 | 20.9 | 69.5 | 126.6 |
| | | bisphenol A | | | | | | |
| | | with 2 mols of | | | | | | |
| | | ethylene oxide | | | | | | |
| | | Adduct of | | | | | 25.2 | 68.9 |
| | | bisphenol A | | | | | | |
| | | with 2 mols of | | | | | | |
| | | propylene | | | | | | |
| | | oxide | | | | | | |
| | | 1,2-propane | 15.0 | 15.1 | 15.2 | 14.4 | 22.3 | |
| | | diol | | | | | | |
| | | 1,3- | | | | | | |
| | | Propanediol | | | | | | |
| | | 1,4-butanediol | | | | | | |
| | | 2,3-Butane | | | | | | |
| | | diol | | | | | | |
| | | Trimethylol | | | 0.2 | 3.8 | 1.6 | |
| | | propane | | | | | | |
| | | 1,2,4-Butane | | | | | | |
| | | triol | | | | | | |
| | | Erythritol | | | | | | |
| | | Pentaerythritol | | | | | | |
| | | 1,2,7-Heptane | | | | | | |
| | | triol | | | | | | |
| | | Glycerol | 0.9 | | | | | |
| | | Sorbitol | | 0.7 | | | | |

| | | | | |
|---|---|---|---|---|
| Polyethylene | 14.3 | 14.4 | 14.5 | 13.7 |
| terephthalate (PET) | | | | |

| Anhydrous trimellitic acid | | 4.8 | 4.8 | 1.9 | 10.6 | 4.8 | 4.8 |
|---|---|---|---|---|---|---|---|
| * Molar ratio (mol percent) | | 33.0 | 33.1 | 33.3 | 31.8 | 49.0 | 0.0 |
| of monomer in alcohol component | | | | | | | |
| Resin properties | Tg (g) | 60.7 | 57.2 | 60.2 | 60.5 | 61.0 | 54.2 |
| | Mw (—) | 17,000 | 14,000 | 16,000 | 15,000 | 16,000 | 12,000 |
| | AV | 20.5 | 21.6 | 8.0 | 30.0 | 21.5 | 18.3 |
| | (mgKOH/g) | | | | | | |
| | OHV | 9.8 | 10.8 | 5.6 | 21.0 | 15.5 | 25.6 |
| | (mgKOH/g) | | | | | | |
| | OHV/AV (—) | 0.48 | 0.50 | 0.70 | 0.70 | 0.72 | — |

TABLE 2

| | | | | | | |
|---|---|---|---|---|---|---|
| Polyester | EM-1 | EM-2 | EM-3 | EM-4 | EM-5 | EM-6 |
| resin | | | | | | |
| emulsion | | | | | | |
| Polyester | A-1 | A-2 | A-3 | A-4 | A-5 | A-6 |
| Resin A | | | | | | |
| Median | 0.24 | 0.24 | 0.23 | 0.26 | 0.21 | 0.23 |
| diameter | | | | | | |
| (D50) (μm) | | | | | | |

| | | | | | | |
|---|---|---|---|---|---|---|
| Polyester | EM-7 | EM-8 | EM-9 | EM-10 | EM-11 | EM-12 |
| resin | | | | | | |
| emulsion | | | | | | |
| Polyester | A-7 | A-8 | A-9 | A-10 | A-11 | A-12 |
| Resin A | | | | | | |
| Median | 0.25 | 0.23 | 0.21 | 0.23 | 0.26 | 0.23 |
| diameter | | | | | | |
| (D50) (μm) | | | | | | |

| Polyester | EM-13 | EM-14 | EM-15 | EM-16 | EM-17 |
|---|---|---|---|---|---|
| resin | | | | | |
| emulsion | | | | | |
| Polyester | A-13 | A-14 | A-15 | A-16 | A-17 |
| Resin A | | | | | |
| Median | 0.25 | 0.26 | 0.24 | 0.23 | 0.24 |
| diameter | | | | | |
| (D50) (μm) | | | | | |
| Polyester | EM-18 | EM-19 | EM-20 | EM-21 | EM-22 |
| resin | | | | | |
| emulsion | | | | | |
| Polyester | A-18 | A-19 | A-20 | A-21 | A-22 |
| Resin A | | | | | |
| Median | 0.22 | 0.27 | 0.26 | 0.22 | 0.22 |
| diameter | | | | | |
| (D50) (μm) | | | | | |

TABLE 3

| * the unit in Table is | | | | |
|---|---|---|---|---|
| represented in parts by mass | | Liquid dispersion of core particle | | |
| otherwise specified. | | CR-1 | CR-2 | CR-3 |
| Manufacturing Method | | Dissolution | Emulsification | Melt- |
| | | suspension | aggregation | kneading |
| Prescription | Amorphous | 82 | 82 | 82 |
| | polyester | | | |
| | resin B | | | |
| | Crystalline | 6 | 6 | 6 |
| | polyester | | | |
| | resin (C) | | | |
| | Ester wax | 6 | 6 | 6 |
| | Cyan pigment | 6 | 6 | 6 |
| Property | Volume | 5.2 | 5.2 | 5.9 |
| | average | | | |
| | particle | | | |
| | diameter | | | |
| | Dv (μm) | | | |
| | Average | 0.972 | 0.945 | 0.936 |
| | circularity (—) | | | |

TABLE 4

| | | Example | Example | Example | Example | Example | Example |
|---|---|---|---|---|---|---|---|
| | | 1 | 2 | 3 | 4 | 5 | 6 |
| Resin Particle T | | T-1 | T-2 | T-3 | T-4 | T-5 | T-6 |
| Toner | | TN-1 | TN-2 | TN-3 | TN-4 | TN-5 | TN-6 |
| Developing agent | | D-1 | D-2 | D-3 | D-4 | D-5 | D-6 |
| Configuration | Core | CR-1 | CR-2 | CR-3 | CR-1 | CR-1 | CR-1 |
| | particle | | | | | | |
| | Shell | EM-1 | EM-1 | EM-1 | EM-2 | EM-3 | EM-4 |
| | Particle | | | | | | |
| Toner | Dv (μm) | 5.1 | 5.3 | 6.2 | 5.2 | 5.1 | 5.0 |
| properties | Average | 0.975 | 0.971 | 0.970 | 0.974 | 0.942 | 0.971 |
| | Circularity | | | | | | |
| Uniformity of | | S | S | A | A | A | A |
| shell layer | | | | | | | |
| Mechanical | | A | A | A | A | A | A |
| durability of toner | | | | | | | |
| Charge | Charge | 5.6 | 4.5 | 8.6 | 3.3 | 6.4 | 5.1 |
| stability | fluctuation | | | | | | |
| | range | | | | | | |
| | (μC/g) | | | | | | |
| | Initial | S | S | S | S | S | S |
| | fogging | | | | | | |
| | Over time | S | S | A | A | A | S |
| | fogging | | | | | | |
| | | Example | Example | Example | Example | Example | Example |
| | | 7 | 8 | 9 | 10 | 11 | 12 |
| Resin Particle T | | T-7 | T-8 | T-9 | T-10 | T-11 | T-12 |
| Toner | | TN-7 | TN-8 | TN-9 | TN-10 | TN-11 | TN-12 |
| Developing agent | | D-7 | D-8 | D-9 | D-10 | D-11 | D-12 |
| Configuration | Core | CR-1 | CR-1 | CR-1 | CR-1 | CR-1 | CR-1 |
| | particle | | | | | | |
| | Shell | EM-5 | EM-6 | EM-7 | EM-8 | EM-9 | EM-10 |
| | Particle | | | | | | |
| Toner | Dv (μm) | 5.2 | 5.2 | 5.3 | 5.2 | 5.0 | 5.0 |
| properties | Average | 0.970 | 0.975 | 0.970 | 0.974 | 0.971 | 0.973 |
| | Circularity | | | | | | |
| Uniformity of | | A | A | A | A | S | S |
| shell layer | | | | | | | |
| Mechanical | | A | A | S | S | A | A |
| durability of toner | | | | | | | |
| Charge | Charge | 8.2 | 4.4 | 8.8 | 6.1 | 5.0 | 4.8 |
| stability | fluctuation | | | | | | |
| | range | | | | | | |
| | (μC/g) | | | | | | |
| | Initial | S | S | S | S | S | S |
| | fogging | | | | | | |
| | Over time | A | S | A | A | A | A |
| | fogging | | | | | | |

| | | Example | Example | Example | Example | Comparative | Comparative |
|---|---|---|---|---|---|---|---|
| | | 13 | 14 | 15 | 16 | Example 1 | Example 2 |
| Resin particle T | | T-13 | T-14 | T-15 | T-16 | T-17 | T-18 |
| Toner | | TN-13 | TN-14 | TN-15 | TN-16 | TN-17 | TN-18 |
| Developing agent | | D-13 | D-14 | D-15 | D-16 | D-17 | D-18 |
| Configuration | Core | CR-1 | CR-1 | CR-1 | CR-1 | CR-1 | CR-1 |
| | particle | | | | | | |
| | Shell | EM-11 | EM-12 | EM-13 | EM-14 | EM-15 | EM-16 |
| | Particle | | | | | | |
| Toner | Dv (μm) | 5.1 | 5.2 | 5.1 | 5.2 | 5.2 | 5.0 |
| properties | Average | 0.975 | 0.974 | 0.974 | 0.970 | 0.974 | 0.970 |
| | Circularity | | | | | | |
| Uniformity of | | A | A | A | A | B | C |
| shell layer | | | | | | | |
| Mechanical | | A | A | S | A | B | C |
| durability of toner | | | | | | | |
| Charge | Charge | 6.6 | 8.9 | 4.8 | 2.9 | 10.9 | 15.4 |
| stability | fluctuation | | | | | | |
| | range | | | | | | |
| | (μC/g) | | | | | | |
| | Initial | S | S | S | S | S | A |
| | fogging | | | | | | |
| | Over time | A | A | S | S | B | C |
| | fogging | | | | | | |

| | | Comparative | Comparative | Comparative | Comparative | Comparative | Comparative |
|---|---|---|---|---|---|---|---|
| | | Example 3 | Example 4 | Example 5 | Example 6 | Example 7 | Example 8 |
| Resin particle T | | T-19 | T-20 | T-21 | T-22 | T-23 | T-24 |
| Toner | | TN-19 | TN-20 | TN-21 | TN-22 | TN-23 | TN-24 |
| Developing agent | | D-19 | D-20 | D-21 | D-22 | D-23 | D-24 |
| Configuration | Core | CR-1 | CR-1 | CR-1 | CR-1 | CR-1 | CR-1 |
| | particle | | | | | | |
| | Shell | EM-17 | EM-18 | EM-19 | EM-20 | EM-21 | EM-22 |
| | Particle | | | | | | |
| Toner | Dv (μm) | 5.0 | 5.1 | 5.2 | 5.2 | 5.2 | 5.2 |
| properties | Average | 0.971 | 0.971 | 0.971 | 0.973 | 0.974 | 0.972 |
| | Circularity | | | | | | |
| Uniformity of | | B | B | C | B | A | A |
| shell layer | | | | | | | |
| Mechanical | | B | B | C | B | A | C |
| durability of toner | | | | | | | |
| Charge | Charge | 12.7 | 10.5 | 14.0 | 6.3 | 18.5 | 10.7 |
| stability | fluctuation | | | | | | |
| | range | | | | | | |
| | (μC/g) | | | | | | |
| | Initial | S | A | A | S | A | S |
| | fogging | | | | | | |
| | Over time | B | B | D | B | C | C |
| | fogging | | | | | | |

Aspects of the present disclosure are, for example, as follows.

### Aspect 1

A polyester resin emulsion for toner contains an aqueous medium and resin particles S dispersed in the aqueous medium, the resin particles S containing a polyester resin A of a polycondensate of an alcohol component and a carboxylic acid component, wherein the alcohol component contains tri- or tetra-valent alcohol having a straight chained or branched aliphatic saturated hydrocarbon backbone with 4 to 6 carbon atoms, the following relationship is satisfied,
0.30≤OHV/AV≤1.00, where AV (mgKOH/g) represents an acid value of the polyester resin A and OHV (mgKOH/g) represents a hydroxyl value of the polyester resin A, AV is between 10 mgKOH/g and 25 mgKOH/g, and
the polyester resin A has a repeated unit derived from polyethylene terephthalate of a condensate of terephthalic acid and ethylene glycol in an amount between 40 percent by mass and 70 percent by mass.

### Aspect 2

The polyester resin emulsion according to Aspect 1 mentioned above, wherein the alcohol component contains trimethylol propane.

### Aspect 3

The polyester resin emulsion according to Aspect 1 or 2 mentioned above for use in shell-forming in manufacturing the toner with a core shell structure of core particles containing a binder resin and a shell covering the core particles.

### Aspect 4

The polyester resin emulsion according to any one of Aspects 1 to 3 mentioned above, wherein the alcohol component comprises at least one member selected from the group consisting of 1,2-propanediol, 1,3-propanediol, 1,4-butanediol, and 2,3-butanediol, the at least one member accounting for at least 30 mol percent of an entire of the alcohol component.

### Aspect 5

The polyester resin emulsion according to any one of Aspects 1 to 5 mentioned above, wherein the resin particles S have a glass transition temperature Tg of from 65 to 75 degrees Celsius at a second temperature rising in a differential scanning calorimetry (DSC).

### Aspect 6

A toner contains a core shell structure containing a core particle containing a binder resin and a shell that covers the core particles, wherein the shell contains a polyester resin A of a polycondensate of an alcohol component and a carboxylic acid component, wherein the alcohol component contains tri- or tetra-valent alcohol having a straight chained or branched aliphatic saturated hydrocarbon backbone with 4 to 6 carbon atoms, the following relationship is satisfied, 0.30≤OHV/AV≤1.00, where AV (mgKOH/g) represents an acid value of the polyester resin A and OHV (mgKOH/g) represents a hydroxyl value of the polyester resin A, AV is between 10 mgKOH/g and 25 mgKOH/g, and the polyester resin A has a repeated unit derived from polyethylene terephthalate of a condensate of terephthalic acid and ethylene glycol in an amount between 40 percent by mass and 70 percent by mass, and the binder resin contains an amorphous polyester resin B.

### Aspect 7

A method of manufacturing resin particles includes dissolving or dispersing at least a polyester resin and a release agent in an organic solvent to obtain a solution or a dispersion; suspending the solution or the dispersion in an aqueous medium to produce a liquid dispersion of core particles; adding the polyester resin emulsion of any one of Aspects 1 to 6 mentioned above to the liquid dispersion of the core particles to form a shell on a surface of the core particles; and removing the organic solvent to manufacture the resin particles with a core-shell structure of the core particles containing a binder resin and the shell covering the core particles.

### Aspect 8

A method of manufacturing a toner includes dissolving or dispersing at least a polyester resin and a release agent in an organic solvent to obtain a solution or a dispersion; suspending the solution or the dispersion in an aqueous medium to produce a liquid dispersion of core particles; adding the polyester resin emulsion of any one of Aspects 1 to 6 mentioned above to the liquid dispersion of the core particles to form a shell on a surface of the core particles; and removing the organic solvent to manufacture the toner with a core-shell structure of the core particles containing a binder resin and the shell covering the core particles.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. A polyester resin emulsion for toner comprising:
an aqueous medium; and
resin particles S dispersed in the aqueous medium, comprising a polyester resin A of a polycondensate of an alcohol component and a carboxylic acid component,
wherein the alcohol component comprises tri- or tetra-valent alcohol having a straight chained or branched aliphatic saturated hydrocarbon backbone with 4 to 6 carbon atoms,
the following relationship is satisfied,
$$0.3 \leq OHV / AV \leq 1. ,$$
where AV (mgKOH/g) represents an acid value of the polyester resin A and OHV (mgKOH/g) represents a hydroxyl value of the polyester resin A,
AV is between 10 mgKOH/g and 25 mgKOH/g, and
the polyester resin A has a repeated unit derived from polyethylene terephthalate of a condensate of terephthalic acid and ethylene glycol in an amount between 40 percent by mass and 70 percent by mass.

2. The polyester resin emulsion according to claim 1, wherein the alcohol component comprises trimethylol propane.

3. The polyester resin emulsion according to claim 1 for use in shell-forming in manufacturing the toner with a core-shell structure of core particles containing a binder resin and a shell covering the core particles.

4. The polyester resin emulsion according to claim 1,
wherein the alcohol component comprises at least one member selected from the group consisting of 1,2-propanediol, 1,3-propanediol, 1,4-butanediol, and 2,3-butanediol, the at least one member accounting for at least 30 mol percent of an entire amount of the alcohol component.

5. The polyester resin emulsion according to claim 1,
wherein the resin particles S have a glass transition temperature Tg between 65 degrees Celsius and 75 degrees Celsius at a second temperature rising in a differential scanning calorimetry.

6. A toner comprising:
a core shell structure comprising:
a core particle comprising a binder resin; and
a shell that covers the core particles,
wherein the shell comprises a polyester resin A of a polycondensate of an alcohol component and a carboxylic acid component,
the alcohol component contains tri- or tetra-valent alcohol having a straight chained or branched aliphatic saturated hydrocarbon backbone with 4 to 6 carbon atoms, the following relationship is satisfied, 0.30≤OHV/AV≤1.00, where AV (mgKOH/g) represents an acid value of the polyester resin A and OHV (mgKOH/g) represents a hydroxyl value of the polyester resin A, AV is between 10 mgKOH/g and 25 mgKOH/g, and,
the polyester resin A has a repeated unit derived from polyethylene terephthalate of a condensate of terephthalic acid and ethylene glycol in an amount between 40 percent by mass and 70 percent by mass, and
the binder resin comprises an amorphous polyester resin B.

7. A method of manufacturing resin particles comprising:
dissolving or dispersing at least a polyester resin and a release agent in an organic solvent to obtain a solution or a dispersion;
suspending the solution or the dispersion in an aqueous medium to produce a liquid dispersion of core particles;
adding the polyester resin emulsion of claim 1 to the liquid dispersion of the core particles to form a shell on a surface of the core particles; and
removing the organic solvent to manufacture the resin particles with a core-shell structure of the core particles comprising a binder resin and the shell covering the core particles.

8. A method of manufacturing a toner comprising:
dissolving or dispersing at least a polyester resin and a release agent in an organic solvent to obtain a solution or a dispersion;
suspending the solution or the dispersion in an aqueous medium to produce a liquid dispersion of core particles;
adding the polyester resin emulsion of claim 1 to the liquid dispersion of the core particles to form a shell on a surface of the core particles; and
removing the organic solvent to manufacture the toner with a core-shell structure of the core particles comprising a binder resin and the shell covering the core particles.
